(19) United States
(12) Patent Application Publication
(10) Pub. No.: US 2013/0337125 A1
(43) Pub. Date: Dec. 19, 2013

(54) MANUFACTURING METHOD OF GLUTEN FREE NOODLE

(71) Applicant: Toshio Kobayashi, Gifu-shi (JP)

(72) Inventor: Toshio Kobayashi, Gifu-shi (JP)

(73) Assignee: KOBAYASHI NOODLE CO., LTD., Gifu (JP)

(21) Appl. No.: 13/523,804

(22) Filed: Jun. 14, 2012

(51) Int. Cl. A23L 1/162; B65B 55/14; B65B 55/19

(52) U.S. Cl. 426/325; 426/412; 426/414; 426/393

(57) ABSTRACT

In a raw material preparing step, a rice powder as a primary raw material powder is added with a water to prepare a mixed raw material. In a kneading step, the mixed raw material is kneaded to form a kneaded substance. In a pressing/extending step, the kneaded substance is pressed and extended to form noodle dough sheet. In a slitting step, the noodle dough sheet is slit into predetermined noodle strand shape to obtain a continuous noodle strand However, these steps maintain a non-alpha state of the rice powder component In a packaging step, a unit-length noodle strand is accommodated in a pouch-like heat-resistant packaging container and hermetically sealed to obtain a packaged unit-length noodle strand, while maintaining a non-alpha state of the rice powder component in the noodle strand.

### BACKGROUND OF THE INVENTION

This invention relates to a manufacturing method of a gluten free noodle including a rice powder noodle and a corn powder noodle as a fresh-type or in a fresh state, particularly to a manufacturing method of a gluten free noodle that uses a manufacturing method similar to a common noodle manufacturing process using a conventional wheat flour as a primary raw material and that makes it possible to manufacture many kinds of noodles in the same manner as the common noodle manufacturing process.

In Japan, there have been proposed these years a rice powder noodle as a noodle that uses rice powders as a raw material in place of the wheat flour as a raw material. On the other hand, the rice powders contain no gluten as in the wheat flour, so that they do not exert any binding/adhering force (a binding force between powders or an effect as a so-called “binder”) by itself even if they are added with water (i.e. blended with the water). Therefore, even if the rice powders as the raw material are added with the water and mixed and kneaded, binding between the rice powders cannot be expected in contrast with the noodle using the wheat flour. Thus, it is difficult to form a noodle strip.

The content of the rice powders have not been regulated for the conventional rice powder noodle. Even if the content of the rice powders are small (e.g. 2%) in the total amount, it can be named as a rice powder noodle. Thus, a noodle having the rice powders added with the wheat flower or gluten is named as a rice powder noodle. In a conventional manufacturing method of a rice powder noodle, the rice powders are added with a starch such as a potato starch and added with water, or they are added with warm water (hot water) and kneaded (that is, the rice powders are kneaded with hot water for forming by use of stickiness of a gelatinized starch unless a binder such as a wheat flour or a gluten is added). Or the rice powders are added with a starch and added with water and they are mixed, and then a steam is supplied to the rice powders added with the water to knead them (i.e. for forming by use of a stickiness of a gelatinized starch by the steam kneading). Thus, the starch goes under an alpha transformation or is gelatinized (i.e. the mixed starch is gelatinized to become a binder or the starch component of the rice powders themselves is transformed into an alpha state depending on a thermal condition of the heated water or the steam for gelatinization) so as to exert a binding force in the raw material powders, thereby providing a kneaded substance of the rice powders by binding the rice powders with each other. Moreover, in the conventional manufacturing method of the rice powder noodle, the kneaded substance of the rice powders after kneading by the hot water or kneading by the steam is extruded and roller-compacted (tightening and solidifying by pressing of a roller or pressing and extending of a stretch roll) so as to form a noodle dough sheet. Then, the noodle dough sheet is cut out into a predetermined noodle strand shape.

A variety of noodles such as an udon or a kishimen the primary raw material powders of which are a wheat flour (referred to as “wheat flour noodle” hereafter) are manufactured by a so-called common noodle manufacturing process (sometimes called as “normal method”). The common noodle manufacturing process basically has a kneading step in which the wheat flour is added with a salt and water (i.e. added with a salt water) and mixed thereafter and the mixed raw material powders are kneaded to obtain a kneaded substance in a block state, a pressing/extending step in which the kneaded substance is pressed and extended to form a noodle dough sheet, and a slitting step in which the noodle dough sheet is slit to obtain noodle strands. In case the noodle is packaged and provided as a packaged noodle product, the noodle strands that were cut out into a predetermined length in the slitting step (or a unit-length-cutting step) (referred to as “unit-length noodle strands” hereafter) are packaged into a packaging container by a vacuum packaging or the like to provide a final noodle product (packaged noodle product).

However, according to the conventional manufacturing method of the rice powder noodle, special steps that are not in the common noodle manufacturing process are required such as the steam kneading step and the extruding step. Therefore, a manufacturing apparatus thereof requires a steam kneading machine for the steam kneading step and an extruding machine for the extruding step. That is, according to the conventional manufacturing method of the rice powder noodle, the special steps and manufacturing apparatus are needed that are different from the common noodle manufacturing process. Moreover, the common noodle manufacturing process can form every kind of noodle strands such as an udon, a kishimen, a ramen, a pasta, a spaghetti and so on as well as a fine-drawin somen and so on. Thus, it enriches the kinds of products (number of goods) and it makes a relatively tasty noodle. Furthermore, it has a high productivity, so that it can obtain effects such as reduction in production costs or the like. In contrast, the conventional manufacturing method of the rice powder noodle is hard to provide a variety of noodle strand shape by the reason that it forms the noodle strands via the steam kneading step and the extruding step. Thus, it can only manufacture limited kinds of noodles (flat noodles only). That is, with the conventional manufacturing method of rice powder noodles, it is hard to press and extend or round the raw material. Moreover, since the efficiency deteriorates, the raw material having the rice powders as a primary raw material powder is applied with heat to transform the rice powder component into alpha state and to make a kneaded substance of a block state. Thereafter, the kneaded substance is extruded to form the noodle strands. However, the noodle strand by the extrusion has basically a flat noodle shape. Though it is possible to form a noodle strand of a round noodle shape (spaghetti type) or a noodle strand of a fine noodle shape, it is very difficult to form a noodle strand of a type (wave noodle) to which a wave is given such as a noodle strand of a ramen state. Moreover, with the conventional manufacturing method of rice powder noodle, it is possible that the productivity becomes low and the production costs rises.

On the other hand, as an invention to manufacture a rice powder noodle, there is proposed an invention disclosed in a patent document No. 1. Moreover, a patent document No. 2 discloses another manufacturing method of rice powder noodle. Each of patent document Nos. 3-7 does not disclose a rice powder noodle but discloses a manufacturing method of a wheat flour noodle that uses a wheat flour as a primary raw material powder.
Patent Publication No. 1: Japanese Patent Laid-Open Patent Publication No. 2007-174911
Patent Publication No. 2: Japanese Patent Laid-Open Patent Publication No. 2006-304674
Patent Publication No. 3: Japanese Patent Laid-Open Patent Publication No. S59-169459
Patent Publication No. 4: Japanese Patent Laid-Open Patent Publication No. H02-249465
Patent Publication No. 5: Japanese Patent Laid-Open Patent Publication No. H09-135670
Patent Publication No. 6: Japanese Patent Laid-Open Patent Publication No. 2002-262795
Patent Publication No. 7: Japanese Patent Laid-Open Patent Publication No. 2003-289818

<Patent Publication No. 1>

First, the patent document No. 1 discloses that a kind of rice powder noodle is manufactured by an extruding step, in which rice powders are kneaded by use of a hot water of less than 100 degrees centigrade to prepare a material and the material is extruded into a noodle shape for forming, and a surface-side alpha transformation step, in which the extruded noodles or the like are passed through a high temperature steam atmosphere less than 100 degrees centigrade for a predetermined time period so as to preferentially transform a starch at a superficial side into alpha state. According to the patent document No. 1, it is described that the rice powder noodle or the like has the starch partially transformed into alpha state so that the degree of gelatinization at the superficial side becomes higher than the interior by the surface-side alpha transformation step, and one can feel a chewy texture and elasticity when eating it.

On the other hand, the invention described in the patent document No. 1 has a material preparing step in which the rice powders are kneaded with the hot water less than 100 degrees centigrade (preferably 85-90 degrees centigrade) to make the block into a minimum necessary alpha transformation degree (gelatinization degree). Moreover, in the surface-side alpha transformation step, the noodle is exposed to the high temperature steam less than 100 degrees centigrade (preferably 88-98 degrees centigrade) for 1-5 minutes to preferentially transform the starch at the surface layer side of the noodle strand into alpha state. Accordingly, in the invention of the patent document No. 1, it is necessary to carry out the alpha transformation (gelatinization) in two steps of the material preparing step and the surface-side alpha transformation step. Thus, it handles the hot water of high temperature and the steam of high temperature over a plurality of times in the manufacturing step of the rice powder noodle or the like. After all, as in the conventional manufacturing method of rice powder noodle, the manufacturing steps for the rice powder noodle or the like become cumbersome and complicated as compared with the common noodle manufacturing process. Moreover, as described above, the invention of the patent document No. 1 executes the alpha transformation for a plurality of times using the hot water of high temperature and the steam of high temperature before a packaging step in the manufacturing steps of the rice powder noodle or the like. Consequently, a cooling step is necessary to cool the material transformed into the alpha state after the alpha transformation until it reaches an ordinary temperature. Thus, in this point, it is possible that the manufacturing steps of the rice powder noodle or the like become cumbersome and complicated, too.

<Patent Publication No. 2>

The patent document No. 2 discloses a manufacturing method of rice powder noodle. However, it has no particular disclosure as to an alpha transformation or gelatinization of a starch component as a noodle constituting component that is an above-mentioned problem proper to the rice powder noodle. That is, the patent document No. 2 has no direct description on the alpha transformation or gelatinization of the starch component as to the rice powder component of a “rice-derived raw material powders” or the noodle strand in any step of a “water adding/hot water adding step”, a “kneading step”, a “pressing/extending step”, a “cutting step” (FIG. 1 and Paragraphs 0023-0027) in the manufacturing method of the rice powder noodle.

<Patent Publication Nos. 3 to 7>

As described later, the patent document Nos. 3-7 disclose a manufacturing method of a conventional common wheat flour noodle that contains the rice powders as a primary raw material powder. However, it never discloses or suggests a manufacturing method of a noodle that uses the rice powders as the primary raw material powder. Moreover, as well known, the manufacturing methods of the wheat flour noodle and the rice powder noodle are very much different depending on whether the primary raw material powders contain the gluten or not. Thus, even a person skilled in the art could not conceive to apply a packaging/heating treatment, based on a construction described in the patent document Nos. 3-7 that relates to a manufacturing technique of wheat flour noodle, to a manufacturing technique of rice powder noodle. This point is described in detail hereafter.

<Difference of Manufacturing Method Depending on Difference of Basic Property (Existence of Gluten) Between Wheat Flour Noodle and Rice Powder Noodle>

As shown below and as well known, the wheat flour contains the gluten, so that the wheat flour noodle using the wheat flour as the primary raw material powder exerts a viscoelastic character in itself by the gluten when added with the water and exhibits a binding effect (i.e. the gluten acts as a binding component), so that no deliberation is necessary on the binding component.

By contrast, the rice powders contain no gluten. Thus, the rice powder noodle using the rice powders as the primary raw material powder does not exert any viscoelastic character in itself when added with the water (i.e. having no such binding component as the gluten). Therefore, a special deliberation is necessary on the binding component.

As a result, as described above, the conventional rice powder noodle manufactures the rice powder noodle by use of the hot water kneading or the steam kneading (each at a pre-stage until the packaging step) “to transform the starch component of the noodle constituting component into the alpha state or gelatinize it by the hot water or the steam (i.e. making the mixed starch gelatinized into a binder or transforming the starch component of the rice powders themselves into the alpha state depending on the thermal condition of the heated water or the steam for the gelatinization), thereby exerting a binding force in the raw material powders. Thus, the rice powders are bound each other to provide the kneaded substance of the rice powders. Moreover, in the conventional manufacturing method of the rice powder noodle, the noodle dough sheet is formed by extruding and roller-compacting (tightening and solidifying by the pressing of the roller or the pressing/extending by the flatting role). Then, the noodle dough sheet is slit into a predetermined noodle strand shape.”

It is obvious from the descriptions of the following public documents (academic documents) in Japan.
Academic Document No. 1: [Heisei 21 Agriculture Study Organization Symposium “Rich Dietary Life Promoted by Rice Powders”, Agriculture Study Organization] Page 11, “2. Development of Manufacturing Technique of Rice Powder Noodle Utilizing <Koshinomenjiman>”
Academic Document No. 2: [Heisei 21 Public Lecture “New Foods Using Rice Powders”, Independent Corporation Agriculture/Food Industrial Technology Multidisciplinary Research Organization, Food Multidiscipline Laboratory], Page 4, “Classification of Rice Powder Noodles”
Academic Document No. 3: [Saitama Prefecture Industrial Technology General Center Study Report the Eighth Volume (2010), Saitama Prefecture Industrial Technology General Center], Page 1, Right Column, Lines 1-4
Academic Document No. 4: [Foods—Its Science and Technology—, 22nd Issue, 1982.3, Ministry of Agriculture, Forestry and Fisheries of Japan, National Food Research Institute], Page 1, “Physicality of Material added with Rice Powder”
Academic Document No. 5: [Research Project on Establishing and Familiarizing of Rice Powder Utilizing Technology, Chiba Prefecture Research and Study (Heisei 16)], Page 2, “(1) About Rice Powder”, “(e) Difference from Wheat Flour”

### BRIEF SUMMARY OF THE INVENTION

In view of the above, it is an object of the present invention to provide a manufacturing method of a gluten-free noodle including a rice powder noodle and a corn powder noodle as a fresh noodle or a fresh-type noodle that, though it uses only gluten-free cereal powder including a rice powder or a corn powder as a primary raw material powder, can manufacture the gluten-free noodle including the rice powder noodle and the corn powder noodle by the conventional common noodle manufacturing process, that increases kinds of noodle strands to enable provision of a wide variety of noodles (particularly forming of wave noodles), that ensures a long period storage in case of being made into a gluten-free noodle product including a packaged rice powder noodle or corn powder noodle, that enables a packaging work to be easily executed, that condensing the number of manufacturing steps to enable reduction of production costs, and that is capable of acquiring elasticity of the noodle over a long period of time.

A manufacturing method of a rice powder noodle as a gluten-free noodle according to a first aspect of the invention is a manufacturing method of a fresh-type rice powder noodle that uses a raw material containing only a rice powder as a primary raw material powder and that manufactures the rice powder noodle by the common noodle manufacturing process. It comprises a raw material preparing step, a kneading step, a pressing/extending step, a slitting step, a packaging step and a heating/alpha transformation step. In the raw material preparing step, a rice powder as a primary raw material powder is added with a water to prepare a mixed raw material, while maintaining a non-alpha state of a rice powder component in the mixed raw material. In the kneading step, the mixed raw material is kneaded to form a kneaded substance, while maintaining a non-alpha state of the rice powder component in the kneaded substance. In the pressing/extending step, the kneaded substance is pressed and extended to form a noodle dough sheet, while maintaining a non-alpha state of the rice powder component in the noodle dough sheet. In the slitting step, the noodle dough sheet is slit into a predetermined noodle strand shape to obtain a continuous noodle strand, while maintaining a non-alpha state of the rice powder component in the continuous noodle strand. In a unit-length cutting step, the continuous noodle strand is cut into a predetermined length to obtain individual unit-length noodle strands, while maintaining a non-alpha state of the rice powder component in the unit-length noodle strand. In the packaging step, the unit-length noodle strand is accommodated in a pouch-like heat-resistant packaging container and hermetically sealed to obtain a packaged unit-length noodle strand, while maintaining a non-alpha state of the rice powder component in the noodle strand. Then, in the heating/alpha transformation step, as an alpha transformation to increase a binding/fixing force as a binding effect between the mutual rice powder components at least at a surface part of each noodle strand of the unit-length noodle strand, the unit-length noodle strand inside the packaging container is uniformly heated only once at a temperature not less than a predetermined temperature, at which the rice powder component in the unit-length noodle strand comes into an alpha state, via a water component in the unit-length noodle strand inside the packaging container, thereby transforming the rice powder component at least at the surface part of each noodle strand of the unit-length noodle strand inside the packaging container and simultaneously sterilizing germs in the unit-length noodle strand.

According to the manufacturing method of the rice powder noodle of the present invention, there is provided a sequence of steps: preparing the raw material using only the rice powder without using any cereal powders (such as a wheat flour or the like) at all other than the rice powder as the primary raw material powder, adding the water and kneading the raw material, pressing and extending the kneaded substance to form the noodle dough sheet, slitting the noodle dough sheet into the predetermined noodle strand shape to form the unit-length noodle strands, and then packaging them in the packaging step. The sequence of the steps formulate a manufacturing method similar to the common noodle manufacturing process for the conventional wheat flour noodle. Consequently, according to the manufacturing method of the rice powder noodle of the invention, although the rice powder is used as the primary raw material powder, a semi-fresh rice powder noodle can be manufactured by utilizing the conventional common noodle manufacturing process that is used as the manufacturing method for the wheat flour noodle. Thus, many kinds of noodle strands can be formed, so that a wide variety of noodle products can be embodied, while improving eating quality. Moreover, the productivity can be maintained high and the production costs can be reduced. That is, by using similar facilities to those of the common noodle manufacturing process for the wheat flour noodle, the rice powder noodle can be manufactured by the process similar to the common noodle manufacturing process for the wheat flour noodle. Therefore, the invention is surely able to solve the problems that special facilities are required to raise the production costs as in the conventional manufacturing method of the rice powder noodle or that special steps are required to cause complexity in the manufacturing steps.

The manufacturing method of the rice powder noodle of the invention is capable of performing the alpha transformation of the starch component of the rice powder for the first time and only once in the heating and alpha transformation step as a final step after the packaging step, while sterilizing the germs in the noodle strands. Consequently, since any heating is not performed on the rice powder in the raw material (primary row material powder, kneaded substance, noodle dough sheet) at all, until the packaging step or in any of the raw material preparing step, the raw material powder kneading step, the kneaded substance pressing/extending step and the noodle dough sheet slitting step, so that the rice powder in the raw material is never transformed into the alpha state until the packaging step. The rice powder in the unit-length noodle strand is transformed into the alpha state only in the one-time and single heating/alpha transformation step after the packaging step and inside an enclosed space of the packaging container. In this alpha transformation, particularly, since the alpha transformation progresses from the surface side of each noodle strand of the unit-length noodle strands toward a center of its interior, the surface part of each noodle strand is completely transformed into the alpha state even with the heating/alpha transformation step at a lowest temperature range, though it depends on the heating temperature and the heating time period in the heating/alpha transformation step. On the other hand, the alpha transformation is executed absolutely in the enclosed space of the packaging container and, basically, there is no water component supply (water component supply by water vapor) from an outside of the packaging container or, even if there is, it is negligible level (i.e. a level having no influence on the alpha transformation efficiency by the water component of the noodle strand itself). Thus, the alpha transformation of the rice powder component progresses basically by utilizing only the water component contained in the noodle strand. Therefore, it is not an alpha transformation at a high moisture content as seen in the alpha transformation of the rice component by a boiling process or a steam-kneading process, but an alpha transformation at a relatively low moisture content (as compared with the boiling process or the steam-kneading process). Accordingly, adherence of the alpha-transformed part at the surface part of the noodle strand becomes relatively low (as compared with the boiling process or the steam-kneading process). Thus, it is possible to surely prevent such troubles as the noodle strands adhere to each other in the packaging container. Moreover, the noodles are smoothly loosened when they are cooked by boiling, too, and no troubles are caused such as the noodle strand are chipped off and lost or the like.

Moreover, the manufacturing method of the rice powder noodle of the invention may use a retort container as the packaging container, and it has a lower permeability (of a gas such as a water vapor) than common plastic packaging containers, so that it is able to improve sealing property. Furthermore, the heating/alpha-transformation step of the invention does not conduct the heating at a high temperature (a temperature more than 100 degrees centigrade that is the evaporating temperature of the water) as in the heating/pressurizing sterilization, but conducts the heating at a temperature range less than the evaporating temperature of the water. Thus, it never deteriorates the quality of the noodle strands in the packaging container.

In addition, in the manufacturing method of the rice powder noodle of the invention, most part of the germs in the unit-length noodle strands are simultaneously sterilized at the temperature where the rice powder is transformed into the alpha state (tough depending on the kinds of the germs). Particularly, the germs in the unit-length noodle strands are nearly sterilized with the heating at a high temperature range.

Accordingly, the manufacturing method of the rice powder noodle of the invention can perform the production of the rice powder noodle by alpha-transformation of the rice powder by executing the single heating/alpha-transformation step only once after the packaging step as a single and only one-time, without changing the steps of the conventional common noodle manufacturing process at all. Particularly, the sterilization is conducted in the state where the rice powder noodle is completely sealed (preferably under an deoxidized state). Thus, no new germs intrude from an outside in the inside of the packaging container (and, in case the interior of the packaging container is in the deoxidized state, the sterilization process is conducted in the state where aerobic microorganisms are restrained beforehand). Consequently, it can improve a preservative quality as the packaged rice powder noodle. At the same time, as compared with the case where the noodle strand has the rice powder transformed in advance into an alpha state in the steam-kneading step or the like before the packaging step and such noodle strand is sterilized in a heating/sterilizing step as a post-step, the noodle strand (before the alpha transformation) that has no rice powder transformed into the alpha state in any way is heated at a temperature range not less than the alpha transformation temperature for a predetermined period of time after the packaging step, thereby conducting both the operations of the alpha transformation and the sterilization at the same time. Therefore, it can finish the alpha transformation step and the sterilization step, which are conducted normally at least as two different steps, as a single step (one step). As a result, it can shorten the manufacturing time for such operations, thus being able to reduce the production costs by more improving the productivity.

In addition, in the manufacturing method of the rice powder noodle of the invention, in case of packaging the noodle strands having the rice powder already transformed into the alpha state by the seam-kneading step before the packaging, the noodle strands at a high temperature state after the steam-kneading need to be cooled once before the packaging, however, the noodle strand before the packaging has a high moisture content and is in the state where the germs are easy to grow, so that there is a possibility that the germs grow in the noodle strands before packaging the noodle strands. By contrast, in the present invention, the noodle strand has a low moisture content as compared with the noodle strand processed by the steam-kneading step. Moreover, it is possible to shorten the time from the formation of the noodle strands to the heating sterilization to a large extent by packaging and heating the noodle strands just after the formation of the noodle strands. Therefore, the simultaneous sterilization is possible by the heating/alpha transformation step after packaging, while restraining growth of the germs in the noodle strand to a large degree, thereby being able to improve the sterilization effect.

In the manufacturing method of the rice powder noodle of the invention, if the heating temperature in the heating/alpha-transformation step becomes higher, the alpha transformation of the rice powder in the noodle strand is promoted more, and the alpha transformation progresses from the surface part to the center part of the noodle strand. Still, if the heating temperature is not less than 55 degrees centigrade at lowest or preferably not less than 60 degrees in terms of a core temperature, the alpha transformation of the rice powder component in the noodle strand is conducted. That is, at least the rice powder component at the surface part of the noodle strand is completely transformed into the alpha state (while the rice powder component at a core part remains non-alpha state).

Moreover, in the manufacturing method of the rice powder noodle of the invention, if a brown rice powder (mixture of a rice powder and a rice bran powder) that is made by pulverizing a brown rice is used as the primary raw material powder, it is necessary to conduct heating at a heating temperature at a higher temperature range than the case of a white rice powder that is made by pulverizing a white rice in order to transform the rice powder component in the noodle strand into the alpha state and to effect the sterilization in the noodle strand. Particularly, in case of using the brown rice powder as the primary raw material powder, the rice bran powder component may affect the binding of the rice powder component and may deteriorate the quality of the noodle strand of the unit-length noodle strand. Therefore, the heating temperature at the higher temperature range than the case of the white rice powder is adopted, so as to ensure good binding by the alpha transformation of the rice powder component in the noodle strands and secure the quality as the noodle strands, thereby being able to largely reduce a percentage defective as the noodle product.

A manufacturing method of a corn powder noodle as a gluten-free noodle according to a second aspect of the invention is a manufacturing method of a corn powder noodle that uses a raw material containing only a corn powder as a primary raw material powder and that manufactures the corn powder noodle by the common noodle manufacturing process. It comprises a raw material preparing step, a kneading step, a pressing/extending step, a slitting step, a packaging step and a heating and alpha transformation step. In the raw material preparing step, a corn powder as a primary raw material powder is added with a water to prepare a mixed raw material, while maintaining a non-alpha state of a corn powder component in the mixed raw material. In the kneading step, the mixed raw material is kneaded to form a kneaded substance, while maintaining a non-alpha state of the corn powder component in the kneaded substance. In the pressing/extending step, the kneaded substance is pressed and extended to form a noodle dough sheet, while maintaining a non-alpha state of the corn powder component in the noodle dough sheet. In the slitting step, the noodle dough sheet is slit into a predetermined noodle strand shape to obtain a continuous noodle strand, while maintaining a non-alpha state of the corn powder component in the continuous noodle strand. In a unit-length cutting step, the continuous strand is cut into a predetermined length to obtain individual unit-length noodle strands, while maintaining a non-alpha state of the corn powder component in the unit-length noodle strands. In the packaging step, the unit-length noodle strands are accommodated in a pouch-like heat-resistant packaging container and hermetically sealed to obtain a packaged unit-length noodle strands, while maintaining a non-alpha state of the corn powder component in the noodle strands. Then, in the heating and alpha transformation step, as an alpha transformation to increase a binding/fixing force as a binding effect between the mutual corn powder components at least at a surface part of each noodle strand of the unit-length noodle strands, the unit-length noodle strand inside the packaging container is uniformly heated only once at a temperature not less than a predetermined temperature, at which the corn powder component in the unit-length noodle strand comes into an alpha state, via a water component in the unit-length noodle strand inside the packaging container, thereby transforming the corn powder component at least at the surface part of each noodle strand of the unit-length noodle strands inside the packaging container and simultaneously sterilizing germs in the unit-length noodle strands.

According to the manufacturing method of the corn powder noodle of the present invention, the same functions and effects are obtained as the manufacturing method of the rice powder noodle.

Further objects and advantages of the invention will be apparent from the following description, reference being had to the accompanying drawings, wherein preferred embodiments of the invention are clearly shown.

### BRIEF DESCRIPTION OF THE SEVERAL VIEW OF THE DRAWING

FIG. 1 is a process chart showing a manufacturing method of a rice powder noodle according to an embodiment of the invention;

FIG. 2 is a plan view showing an example of a packaged rice powder noodle product manufactured by the manufacturing method of the rice powder noodle according to the embodiment of the invention;

FIG. 3 is a front elevation view showing the example of the packaged rice powder noodle product manufactured by the manufacturing method of the rice powder noodle according to the embodiment of the invention, whereas it is depicted as a drawing showing noodle strands at an inside of a packaging container, while opening an opening side end of the packaging container;

FIG. 4 is a process chart showing a manufacturing method of a rice powder noodle according to a second embodiment of the invention;

FIG. 5 is a process chart showing a manufacturing method of a rice powder noodle according to a third embodiment of the invention;

FIG. 6 is a process chart showing an example of a packaging process according to an embodiment of the invention;

FIG. 7 is a plan view showing an example of a packaged rice powder noodle product manufactured by the manufacturing method of the rice powder noodle according to the embodiment of the invention;

FIG. 8 is an end elevation view of FIG. 7 along the line VIII-VIII.

### DETAILED DESCRIPTION OF THE INVENTION

Embodiments for embodying the present invention (referred to as embodiment(s) hereafter) are described hereafter. First, as a premise of a manufacturing method of a rice powder noodle according to the present invention, knowledge that the inventor has obtained in the process of conceiving the present invention.

[Increase of Noodle Kinds of Fresh-type Rice Powder Noodles by Common Noodle Manufacturing Process]

At the beginning, the inventor studied the problems of the above-mentioned conventional manufacturing method of the rice powder noodle. Then, the inventor thought that, if the common noodle manufacturing method used for the conventional wheat flour noodle could be applied to the manufacture of the fresh-type rice powder noodle, many kinds of noodles (particularly the wave noodle) could be provided for the rice powder noodle as in the wheat flour noodle. Thus, the inventor conducted repeated studies and experiments for the development of a noodle manufacturing method using only the rice powder as the primary raw material powder and, as a result, conceived the present invention. The “fresh-type” noodle used in the present application means a noodle that has a flexibility in the same manner as common fresh noodles (or differently from dry noodles) but does not mean a noodle without any alpha transformation of noodle strands as in the common fresh noodles. Still, it means a noodle that has at least a surface part of the noodle strand (preferably an entirety from the surface part to a core part of the noodle strand) transformed into an alpha state by a heating/alpha transformation step, while being eatable with a boiling process for a predetermined time period (nearly about 2-4 minutes). The boiling process time of the rice powder noodle of the present invention thus manufactured (about 1 minute for fine noodle such as the somen and about 2 to about 4 minutes for noodles having a normal thickness) becomes a shorter time than a boiling process time of the rice powder noodle by the conventional manufacturing method (extrusion). Moreover, the manufacturing method of the rice powder noodle according to the present invention that uses the common noodle manufacturing method is excellent in ease and convenience as compare with the other conventional manufacturing methods of the rice powder noodles. On the other hand, in the developing process, the inventor found the following problems and continued research and development to solve the problems. As a result, the inventor had further knowledge and added characteristics on the basis of such knowledge to the present invention.

[Securement of Long Preservative Quality]

That is, first, in case of making a noodle by simply utilizing the common noodle manufacturing method by use of a raw material powder having only the rice powder as a primary raw material powder, as mentioned above, the rice powder is not sufficiently bound in the kneading step due to lack of the binding force of the rice powder itself. Thus, it is necessary to provide means or steps to compensate for the lack of the binding force. Conventionally, the starch component of the rice powder is transformed in to the alpha state by the hot water kneading or the stem kneading as the kneading to compensate for the lack of the binding force. However, for example, if the wheat flour noodle is made into the fresh-type noodle with the starch transformed into the alpha state, it is generally said that the germs are easy to grow (though it would be related to increase of moisture content by the hot water kneading or the steam kneading) as compared with the case in which it is not transformed into the alpha state and that the noodle is easy to decay. Particularly, a problem is indicated that it is impossible to ensure the long preservative quality at a normal temperature. Such point is thought to apply to the rice powder noodle. If the long preservative quality at the normal temperature can be ensured for the rice powder noodle, the commodity value can be heightened more. Then, the inventor conducted repeated investigations and studies for the development as to the means and the steps for ensuring the long preservative quality at the normal temperature for the rice powder noodle, in the manufacturing method of the rice powder noodle of the present invention, thereby adding them as the characteristics of the present invention.

[Smoothness of Packaging Work]

Moreover, in the wheat flour noodle, generally speaking, if it is made into the fresh-type noodle with the starch component transformed into the alpha state, the surface of the noodle strand is covered by a film of a gelatinized starch, so that the noodle strands adhere when packaging the unit-length noodle strands in the packaging container, thereby possibly causing troubles for the packaging work. Such problem is thought to apply to the rice powder noodle. The inventor conducted repeated investigations and studies for the development as to the means and the steps for preventing the noodle strands from adhering at the time of packaging of the rice powder noodle, in the manufacturing method of the rice powder noodle of the present invention, thereby adding them as the characteristics of the present invention.

[Securement of Elasticity of Noodle]

Furthermore, in the wheat flour noodle, generally speaking, in case of the noodle manufacturing method to make the fresh-type noodle with the starch component transformed into the alpha state by the heated water such as in the boiling process or the steam kneading process or the like, a gradient of moisture is formed such that the moisture content decreases from the surface part to the core part of the noodle strand. Then, smoothness is given at the surface of the noodle strand, whereas a core-like part as a relatively stiff part (part with relatively low moisture content) remains at the core part of the noodle strand, thereby providing elasticity of the noodle. However, in this case, if the moisture content of the noodle strand becomes too high, the moisture content at the core part of the noodle strand becomes high and looses the elasticity. Therefore, a condition setting and a condition management may become cumbersome and complicated for controlling the moisture content in the boiling process or the stem kneading process. Moreover, in case of properly conducting the condition setting and the condition management for controlling the moisture content in the boiling process or the stem kneading process, if the alpha-transformed noodle strands are left for a considerable time period after the boiling process or the steam kneading process, after all, the moisture at the surface part of the noodle strand moves to the core part of the noodle strand. Thus, it is possible that the core part of the noodle strand be softened and the elasticity of the noodle be lost, thereby possibly making the time management cumbersome and complicated in the steps after the alpha transformation of the noodle strands. Such point is thought to apply to the rice powder noodle. Then, the inventor conducted repeated investigations and studies for the development as to the means and the steps for keeping the elasticity of the noodle in the rice powder noodle, thereby adding them as the characteristics of the present invention.

[Addition of Utility by Diversifying Commodity Distribution of Noodle Product]

Moreover, the conventional manufacturing methods of the rice powder noodle, including the patent document No. 2, just focus on the point that the noodle produced by the manufacturing stage (i.e. one just after the production) is formed into a predetermined noodle strand shape (i.e. such that the noodle strand does not break or lose its shape). They study the manufacturing conditions or the manufacturing steps in such viewpoints. On the other hand, the inventor has had an idea that, though the state in the production stage or just after production was of course important for the noodle product, it was very important to surely primarytain the noodle strand shape thereafter at the stage of distribution or during commodity distribution in order to enable a great variety of commodity distribution. Thus, the inventor continued keen research and development from such point of view and conceived the present invention after repeating many trials and errors. That is, if the noodle strand shape of the noodle product is surely maintained at the distribution stage or the physical distribution stage, it is possible to adopt a wide variety of commodity distribution methods according to means for commodity distribution and needs of consumers. Then, it is possible to largely heighten the utility for traders and retail consumers. By contrast, the conventional manufacturing methods of the rice powder noodles do not focus on such points at all. Therefore, it is highly possible that the noodle shape of the noodle product is broken or loses its shape at the commodity distribution stage. If no troubles are caused at the commodity distribution stage, it is highly possible that the noodle strand break or lose its shape at the time of boiling when the noodle product is cooked.

[Rice Powder Noodle of the Invention and Conventional Wheat Flour Noodle]

First, in the manufacturing method of the rice powder noodle of the present invention, the rice powder as the primary raw material powder is gluten-free (i.e. contains no gluten at all that is contained in the wheat flour). Thus, any binding effect of a noodle constituting component by the gluten cannot be expected at all as in the conventional wheat flour noodle. In such point, the present invention is the one that has been finished on the basis of focus and technical idea that are totally different from the conventional manufacturing method of the wheat flour noodle.

That is, there is a big difference in the manufacturing methods, depending the existence and non-existence of the gluten, between the one of the rice powder noodle and the one of the wheat flour noodle. Thus, it is unreasonable to take the noodle using the rice powder as the primary raw material (rice powder noodle) and the noodle using the wheat flour as the primary raw material (wheat flour noodle) simply as the same sort of noodle (as a noodle using a cereal powder as the primary raw material). It is not obvious for a person skilled in the art at all to apply each of the manufacturing steps of the conventional manufacturing method of the wheat flour noodle (e.g. the manufacturing methods of the patent documents Nos. 3-7) to the conventional manufacturing method of the rice powder noodle (e.g. the manufacturing method disclosed in the patent document No. 1).

Moreover, as shown in the academic document No. 4, though there has been an idea of the manufacturing method of the rice powder noodle using the rice powder as the primary raw material powder long before the completion of the present invention, only the heating step before the packaging step such as the steam kneading (or steaming) or the hot water kneading (or hot water pugging) has been proposed in each method as binding means (binding method) of the rice powder component. There has been no idea that the noodle strand composed of the rice powder is processed by the heating/alpha-transformation treatment just after it is accommodated in the enclosed space of the packaging container, as “an alpha transformation to increase a binding/fixing force as a binding effect between the mutual rice powder components at least at a surface part of each noodle strand of the unit-length noodle strands” conducted via “a water component in the unit-length noodle strand inside the packaging container”. In view of such facts (and in view of the facts that the present invention has actually achieved productization on the basis of the above-mentioned idea that is novel and hard to be conceived), a person skilled in the art cannot conceive the present invention even if he or she could apply the conventional manufacturing method of the wheat flour noodle to the conventional manufacturing method of the rice powder noodle.

[Manufacturing Method of Rice Powder Noodle of First Embodiment]

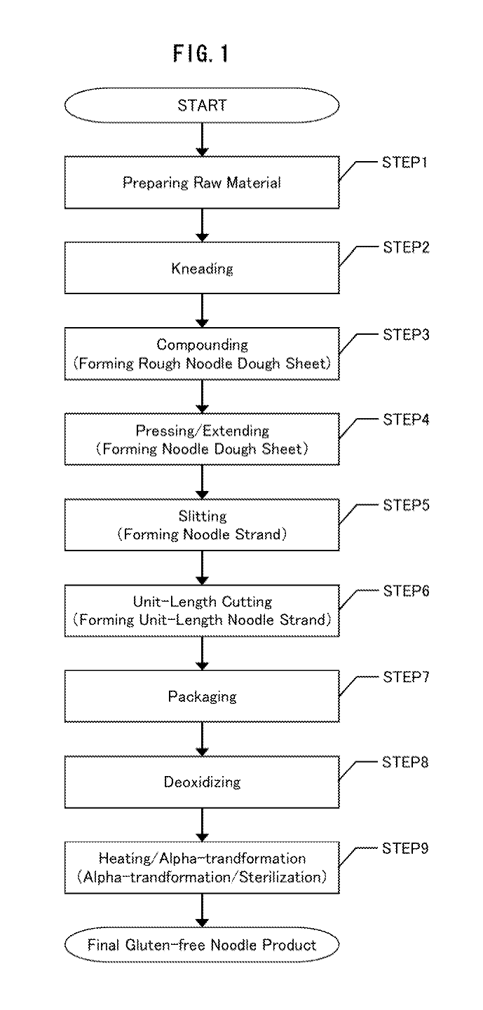

The manufacturing method of the rice powder noodle according to the first embodiment of the present invention is described hereafter referring to FIG. 1. As shown in FIG. 1, the manufacturing method of the rice powder noodle according to the present embodiment has a sequence or group of steps of a raw material preparing step STEP 1, a kneading step STEP 2, a compounding step (rough noodle dough sheet forming step) STEP 3, a pressing/extending step (noodle rough sheet forming step) STEP 4, a slitting step (noodle strand forming step) STEP 5, a unit-length cutting step (unit-length noodle strand forming step) STEP 6, a packaging step STEP 7, a deoxidizing step STEP 8 and a heating/alpha-transformation step (alpha-transformation/sterilizing step) STEP 9. Each step is described in detail hereinafter.

<Raw Material Preparing Step>

The raw material used in the manufacturing method of the rice noodle of the present embodiment is composed of a mixed raw material that is made of a predetermined raw material powder (a primary raw material powder and a secondary raw material powder), an additive that is added where necessary and a water (fresh water) that is added at a fixed rate thereto. The raw material powder is prepared so as to be composed of a mixed powder that is made by mixing the primary raw material powder and the secondary raw material powder or so as to be composed of them added with the additive in STEP 1. Specifically, the primary raw material powder consists of only a rice powder (correctly a white rice powder) that is obtained by finely grinding a white rice. Alternatively, the primary raw material powder consists of only a rice powder (correctly a brown rice powder) that is obtained by finely grinding a brown rice. The brown rice powder contains a pulverized rice bran component in addition to a white rice component of a pulverized white rice powder. Alternatively, the primary raw material powder may consist of only a rice powder (correctly a sprouted rice powder) that is obtained by finely grinding a sprouted rice (haigamai). Alternatively, the primary raw material powder may consist of only a rice powder (correctly a sprouted brown rice powder) that is obtained by finely grinding a sprouted brown rice (hatsuga-genmai). Alternatively, the primary raw material powder may consist of only a rice powder (correctly a mixed rice powder) that mixes any two or more kinds the white rice powder, the brown rice powder, the sprouted rice powder or the sprouted brown rice powder. At any rate, the primary raw material powder consists only of the above-described rice powder and contains no component at all (like wheat flour and the like) other than the rice powder. The raw material powder may be a raw material powder (100% rice powder) that consists only of the rice powder as the primary raw material powder. In this case, a rice powder is used that is composed of a starch component having a structure that the starch component is easy to bind even in a non-alpha state.

On the other hand, the secondary raw material powder is mixed in the rice powder as the primary raw material powder to constitute part of the raw material powder and to function as a binding component that compensates for a binding force between respective powders of the rice powder. The secondary raw material powder consists of an alpha rice powder or a modified starch such as an alpha starch or the like. The alpha starch is a kind of the modified starch. As the secondary raw material powder, one kind of the alpha rice powder, the alpha starch and the other modified starch may be used alone or, alternatively, a combination of any plural kinds of them may be used. It is preferable to use the alpha rice powder in view of a compatibility with the rice powder as the primary raw material powder or in order to avoid an allergy or the like that may be caused by a starch (alpha wheat flour or the like) other than the rice-derived starch. The alpha rice powder is the one obtained by finely grinding an alpha rice. If the alpha rice powder is mixed in the rice powder as the primary raw material powder, all (100%) of the raw material powder (mixed powder) can be composed of the rice powder (the non-alpha rice powder and the alpha rice powder). That is, unless the raw material powder consist of 100% rice powder, basically, it is preferable to add the alpha rice powder as the secondary raw material powder to the rice powder as the primary raw material powder. Moreover, the additive is added to the rice powder as the primary raw material powder and the secondary raw material powder to constitute part of the mixed material and to improve physical property of the raw material powder. The additive may consist of a thickener as a thickener/thickening-stabilizer or a polysaccharide thickener or the like.

Specifically, the raw material is composed of the primary raw material powder A, the secondary raw material powder B and the additive C. Examples of its composition is shown below. Raw Material Composition Example No. 1: Only the primary raw material powder (rice powder) A Raw Material Composition Example No. 2: The primary raw material powder (rice powder)+the secondary raw material powder B (one kind or any plural kinds of the alpha rice powder, the alpha starch and the modified starch); Raw Material Composition Example No. 3: The primary raw material powder (rice powder) A+the additive C; Raw Material Composition Example No. 4: The primary raw material powder (rice powder)+the secondary raw material powder B+the additive C

As the additive, one kind of any plural kinds of the following (a), (b), (c) and (d) may be used. Additive (a): Modified starch as a thickener; Additive (b): Guar gum or Xanthane gum or the like; Additive (c): Vinegar, Spiritus (ethyl alcohol), pH adjuster, Fermented seasoned liquid or the like (one kind or any plural kinds thereof); Additive (d): Sugar for anti-aging of starch

As the additive, a polysaccharide thickener using both the guar bum and the xanthane gum may be added, for example. Moreover, among the above-listed additives, it is preferable to use a starch sugar of nearly a disaccharide or a trisaccharide such as a trehalose or a maltose as the (d) sugar for anti-aging of starch. In this case, it is possible to effectively prevent aging of the starch component of the rice powder transformed into an alpha state in a heating/alpha-transformation step that is described later. Among the above-listed additives, either the vinegar or the spiritus exerts a sterilizing effect to improve preserving property of the noodle. The vinegar exerts a function as a pH adjuster, too. Moreover, among the additives, either the pH adjuster or the fermented seasoned liquid exerts a sterilizing effect to improve preserving property of the noodle. Furthermore, the pH adjuster adjusts a level of an acidity and an alkalinity in the noodle to prevent change in quality or change in color of the noodle, thus being able to stabilize the quality or improving transubstantiation or improve effects of the other additive. In addition, the fermented seasoned liquid is able to improve taste of the noodle. Moreover, the sugar for the anti-aging of the starch is able to prevent the aging of the starch component to avoid the aging the rice powder noodle.

As described above, it is possible to add the thickener or the polysaccharide thickener as the additive to the raw material or to add the vinegar or the spiritus (ethyl alcohol) or the like as the additive in the same manner. As the additive, it is preferable to add at least the thickener or the polysaccharide thickener. Thereby, it is possible to increase viscosity at the time of kneading of the raw material or the like for improving the binding property of the rice powder or to improve a moisture retention effect or to improve a texture in eating after it is made into the noodle product. Moreover, in case the thickener or the polysaccharide thickener as the additive, the thickener or the polysaccharide thickener prevents the aging (return beta transformation) of the alpha-transformed rice powder component in the noodle strand (after the heating/alpha-transformation described later). The modified starch may be used as the aforementioned secondary raw material powder or as the aforementioned additive. In case the modified starch is used as the additive, it acts as a thickener or a texture improving agent.

The raw material used in the manufacturing method of the rice powder noodle of the present embodiment is preferably prepared by blending the above-mentioned primary raw material powder (rice powder), the secondary raw material powder and (as needed) the additive at a predetermined proportion (predetermined blending ratio) and adding the water and mixing them. The blending ratio (mixing rate) of the raw material powder (primary raw material powder and secondary raw material powder) is set such that the secondary raw material powder is blended at a range of about 0.5 to about 20% to the main raw material powder (rice powder) blended at a range of about 80 to about 99.5%, for example. Then, it is set such that the raw material become 100 weight % by blending the primary raw material powder and the secondary raw material powder at a desired blending ratio selected from these ranges. Moreover, in case of using the alpha rice powder as the secondary raw material powder, the alpha rice powder is blended within a range of about 3 to about 10 parts by weight to 100 parts by weight of the rice powder. Preferably, the alpha rice powder is blended within a range of about 5 parts by weight to 100 parts by weight of the rice powder. As described above, in case the raw material powder is formulated by the rice powder alone (100% rice powder) as the primary raw material powder (that is not transformed into the alpha state), the blending ratio of the secondary raw material powder is naturally “0%”. Moreover, the addition rate of the additive to thus prepared raw material powder may be about 1 parts by weight to 100 parts by weight of the raw material powder. Still, the kinds of the addition rate of the additive may be changed appropriately according to a desired physical property given to the noodle strands. For example, the polysaccharide thickener as the additive may be added to the above-mentioned raw material powder within a range of about 1 to about 2% (so that the total becomes 100 weight %). Within the above-mentioned range of the blending ratio, when the raw material is prepared and supplied to the next kneading step or the like, a sufficient binding force is ensured between the rice powders (i.e. the rice powders are surely bound), thereby being able to surely maintain a fixed shape as the noodle strand. Of course, it is possible to eliminate the additive.

The water added to the raw material powder is not a salt water as in the wheat flour noodle (it is desirable to use the salt water to densify the gluten) but a fresh water. The addition amount thereof in the raw material may be a water addition range similar to a water addition range in a raw material of a common rice powder noodle in a fresh noodle state (e.g. about 35 to about 75 parts by weight of the fresh water to 100 parts by weight of the raw material powder, preferably about 45 to about 65 parts by weight of the fresh water to 100 parts by weight of the raw material powder). Moreover, in the raw material preparing step STEP 1, the water added to the raw material powder is a water at a normal temperature and is not a hot water or a heated water. That is, it is a water at a temperature range at which the rice powder of the raw material powder is never transformed into the alpha state. Thus, the rice powder of the raw material powder is never transformed into the alpha state at all in the raw material preparing step. Namely, the raw material preparing step STEP 1 is conducted at a temperature less than a alpha-transformation temperature range (correctly a normal temperature range falling considerably below the alpha-transformation temperature range) of the rice powder in the mixed raw material. In the raw material step STEP 1, all the rice powder component is kept at the non-alpha state.

<Particle Size of Rice Powder>

The rice powders as the primary raw material used in the manufacturing method of the rice powder noodle of the present embodiment are preferably made by milling or a fine-grinding using a prescribed micro-pulverization apparatus so as to be a predetermined particle size (particle diameter), thereby being prepared into fine-particle rice powders of the predetermined particle size (average particle size). Moreover, as described above, thus prepared fine-particle rice powders are blended with the above-mentioned secondary raw material powder and the additive as needed, thereby preparing the raw material composed of the mixture. Specifically, the primary raw material powder is made by micro-pulverization within a first particle size range of an average particle size of about 100 to about 1300 meshes (about 150 to about 10 micrometers), preferably within a second particle size range of an average particle size of about 200 to about 900 meshes (about 75 to about 15 micrometers), more preferably within a third particle size range of an average particle size of about 325 to about 900 meshes (about 45 to about 15 micrometers), most preferably within a fourth particle size range of an average particle size of about 30 micrometers or nearly around 30 micrometers. In case the particle size of the primary raw material powder is at a relatively large value range within the above-mentioned predetermined range (e.g. within a range of about 100 to about 170 meshes (about 150 to about 90 micrometers)), it is desirable to blend the secondary raw material powder and the additive within the range of the above-mentioned rate into the main raw material powder to prepare the raw material, in order to exert the binding effect of the rice powder noodle of the present invention as the final product in a robust state and stable over a long period of time.

On the other hand, in case the particle size of the primary raw material powder is at a relatively small value range within the above-mentioned predetermined range (e.g. within a range of a mesh size more than about 170 meshes (i.e. less than about 90 micrometers), or within a range of a mesh size more than about 200 meshes (i.e. less than about 75 micrometers), or, preferably, within a range of a mesh size more than about 270 meshes (i.e. less than about 53 micrometers) or within a range of a mesh size more than about 325 meshes (i.e. less than about 45 micrometers)), it is possible to manufacture the rice powder noodle of the present invention as the final product only with such primary raw material powder alone. That is, the powders of the primary raw material powder composed of the rice powders having such fine average particle size are mutually bound with each other by a relatively strong intermolecular force, since comparatively many functional groups of the starch particles exist on the surface of the powders by a relatively large surface area of each powder. Thus, even if it is not mixed with the secondary raw material powder or the additive such as the above-mentioned alpha rice powder or the like or the polysaccharide thickener or the like, it is possible to exert the binding effect of the rice powder noodle of the present invention as the final product at a robust state and stably over a long period of time. Still, of course, even in case of using the rice powders of such fine average particle size, if it is mixed with the secondary raw material powder or the additive such as the above-mentioned alpha rice powder or the like or the polysaccharide thickener or the like, it is possible to exert the binding effect of the rice powder noodle of the present invention as the final product at a more robust state and more stably over a longer period of time.

<Kind of Rice Powder>

As the rice powder, a rice powder or a brown rice powder obtained by finely grinding a low-amylose rice having a low content rate of amylose and a high content rate of amylopectin (preferably, an uruchi-rice (uruchimai) or a japonica rice or a brown rice thereof having the content rate of amylopectin not less than 80%, more preferably an uruchi-rice (uruchimai) or a japonica rice or a brown rice thereof having the content rate of amylopectin of 100%) into the above-mentioned particle size range.

<Blending Ratio of Materials>

As a rice powder composed of a starch component having a structure in which the above-mentioned starch is easy to bind even at a non-alpha state, for example, the rice powder having the above-mentioned average particle size may be used. In this case, it may be a raw material powder consisting only of the rice powder as the main raw material powder (100% rice powder), too. On the other hand, in the manufacturing method of the rice powder noodle of the present invention, if the finely pulverized rice powders as the primary raw material powder becomes coarser (i.e. if the average particle size become larger), the binding force between the powders of the rice powder becomes weaker. Therefore, in order to obtain more robust binding force, it is desirable to mix the secondary raw material powder and the additive to compensate for the binding force, while make adjustment by increasing the blending ration of them. For example, in case the rice powder has the average particle size of the above-mentioned first particle size range (about 150 to about 10 micrometers), the secondary raw material powder is set at a blending ratio (mixing ratio) within a range of about 0.5% to about 20% to the primary raw material powder (rice powder) of about 80 to about 99.5% in the raw material powder. In case the rice powder has the average particle size of the above-mentioned second particle size range (about 75 to about 15 micrometers), the secondary raw material powder is set at a blending ratio (mixing ratio) within a range of about 0.5% to about 15% to the primary raw material powder (rice powder) of about 85 to about 99.5% in the raw material powder. In case the rice powder has the average particle size of the above-mentioned third particle size range (about 45 to about 15 micrometers), the secondary raw material powder is set at a blending ratio (mixing ratio) within a range of about 0.5% to about 10% to the primary raw material powder (rice powder) of about 90 to about 99.5% in the raw material powder. In case the rice powder has the average particle size of the above-mentioned fourth particle size range (nearly around 30 micrometers), the secondary raw material powder is set at a blending ratio (mixing ratio) within a range of about 0.5% to about 5% to the primary raw material powder (rice powder) of about 95 to about 99.5% in the raw material powder.

<Kneading Step>

The mixed material prepared in the raw material preparing step STEP 1 is supplied to a kneading machine (though it may be called as a mixing/kneading machine, a mixing machine, a mixer or the like) as a kneading apparatus, in the kneading step STEP 2. Then, it is kneaded to be formed into a predetermined kneaded substance (kneaded bulk such as a dough or the like). Even in this kneading step STEP 2, the mixed material or the kneaded material is never warmed or heated at all, so that the rice powder in the raw material is never transformed into the alpha state at all. That is, the kneading step STEP 2 is carried out at a temperature range less than the alpha-transformation temperature range of the rice powder in the mixed material and in the mixed substance (correctly a normal temperature range considerably falling below the alpha transformation temperature range). Consequently, in the kneading step STEP 2, all the rice powder component is kept at the non-alpha state.

<Compounding Step (Rough Noodle Dough Sheet Forming Step)>

The kneaded substance formed in the kneading step STEP 2 is supplied to a compounding machine as a compounding apparatus, in the compounding step STEP 3. Then, it is pressed and extended into a plurality of rough noodle dough sheets. Thereafter, the plurality of layers of rough noodle dough sheets are stacked up to be formed into a predetermined compounded noodle sheet (in which the noodle sheets are stacked up in the plural layers). Even in this compounding step STEP 3, the mixed material or the kneaded material or the compounded noodle sheet is never warmed or heated at all, so that the rice powder in the raw material is never transformed into the alpha state at all. That is, the compounding step STEP 3 is carried out at a temperature range less than the alpha-transformation temperature range of the rice powder in the mixed material and in the rough noodle dough sheets and in the compounded noodle sheet (correctly a normal temperature range considerably falling below the alpha transformation temperature range). Consequently, in the compounding step STEP 3, all the rice powder component is kept at the non-alpha state.

The kneading step STEP 2 and the compounding step STEP 3 may be grasped as a kneading/compounding step by a line of a mixing machine and a compounding machine (e.g. an apparatus integrating these machines). Moreover, it is possible to provide a rough noodle sheet forming step STEP 3 for forming a rough noodle sheet in only one layer, while eliminating the compounding step STEP 3 or in place of the compounding step STEP 3. In this case, a separate apparatus may be used for forming the rough noodle sheet. However, it is possible to form the rough noodle sheet by a pressing/extending apparatus. That is, it may be embodied as a pressing/extending step to press and extend the kneaded substance from a noodle dough sheet having a large thickness (rough noodle dough sheet equivalent) to a noodle dough sheet having a small thickness (noodle dough sheet having a final thickness as same as a thickness of a noodle strand) in the next pressing/extending step STEP 4. In this case, it is possible to eliminate the rough noodle dough sheet forming step STEP 3 (that is independent from the pressing/extending step). At any rate, the steps from the kneading step STEP 2 to the step before the pressing/extending step can be grasped as a step for shaping the kneaded substance formed in the kneading step STEP 2 into the rough noodle dough sheet shape to supply for the next stage of the pressing/extending step STEP 4. Normally, it is preferable to form the rough noodle dough sheet as the layered noodle dough sheet by the compounding step and to press and extend it in the next stage of the pressing/extending step.

<Pressing/Extending Step>

The layered noodle dough sheet as the rough noodle dough sheet formed in the compounding step (rough noodle dough sheet forming step) STEP 3 (a single layer of rough noodle sheet in case of eliminating the compounding step STEP 3 or in case of providing the rough noodle dough sheet forming step and compounding step STEP 3 in place of the compounding step STEP 3) is supplied to a pressing/extending machine. Then, it is shaped into a predetermined shape of noodle dough sheet (thin noodle dough sheet shape having a fixed width and a same thickness as the final noodle product) by pressing and extending (flatting by a stretch roller). Even in this pressing/extending step STEP 4, the noodle dough sheet is never warmed or heated at all, so that the rice powder in the raw material is never transformed into the alpha state at all. That is, the pressing/extending step STEP 4 is carried out at a temperature range less than the alpha-transformation temperature range of the rice powder in the noodle dough sheet (correctly a normal temperature range considerably falling below the alpha transformation temperature range). Consequently, in the pressing/extending step STEP 4, all the rice powder component is kept at the non-alpha state. In the pressing/extending step STEP 4, in case of pressing and extending the layered noodle dough sheet obtained as the rough noodle dough sheet in the compounding step STEP 3, the air is entrapped in the noodle dough sheet at the time of pressing and extending. However, the taste becomes an original taste of the noodle when it is made into the noodle strand, thereby being able to provide an excellent quality as a taste quality.

<Slitting Step>

The noodle dough sheet formed in the pressing/extending step STEP 4 is supplied to a slitting machine in the slitting step (noodle strand forming step) STEP 5. Then, it is slit into a predetermined noodle strand shape (noodle strand shape having a predetermined noodle strand width as same as the final noodle product). Even in this slitting step STEP 5, the noodle dough sheet or the noodle strand is never warmed or heated at all, so that the rice powder in the raw material is never transformed into the alpha state at all. That is, the slitting step STEP 5 is carried out at a temperature range less than the alpha-transformation temperature range of the rice powder in the noodle dough sheet or in the noodle strand (correctly a normal temperature range considerably falling below the alpha transformation temperature range). Consequently, in the slitting step STEP 5, all the rice powder component is kept at the non-alpha state. The pressing/extending step STEP 4 and the slitting step STEP 5 can be grasped as a single step (e.g. a step to be called as a pressing/extending/slitting step) by a line of a pressing/extending apparatus and a slitting machine (e.g. an apparatus integrating them).

<Unit-Length Cutting Step>

The noodle strands formed in the slitting step STEP 5 is supplied to a fixed-length cutting apparatus in the unit-length cutting step STEP 6. Then, it is cut into a fixed length (same length as each noodle strand length of the final noodle product) to be a unit-length noodle strand, and is thereafter arranged into a predetermined packaging shape (preferably double-folded with a top and bottom of a same length). Even in this unit-length cutting step STEP 6, the noodle strand is never warmed or heated at all, so that the rice powder in the raw material is never transformed into the alpha state at all. That is, the unit-length cutting step STEP 6 is carried out at a temperature range less than the alpha-transformation temperature range of the rice powder in the noodle strand (correctly a normal temperature range considerably falling below the alpha transformation temperature range). Consequently, in the unit-length cutting step STEP 6, all the rice powder component is kept at the non-alpha state. The unit-length cutting step STEP 6 can be grasped as a single step with the slitting step STEP 5 by a line of apparatus with the slitting step STEP 5 (e.g. an apparatus integrating them) (e.g. it can be grasped as a slitting/cutting step or simply grasped as a slitting step). Moreover, the unit-length cutting step STEP 6 can be grasped as a single step with the pressing/extending step STEP 4 and the slitting step STEP 5 (e.g. a step to be called as a pressing/extending/slitting/cutting step/cutting step or a pressing/extending/slitting step) by a line of apparatus with the pressing/extending step STEP 4 and the slitting step STEP 5 (e.g. an apparatus integrating them).

<Packaging Step>

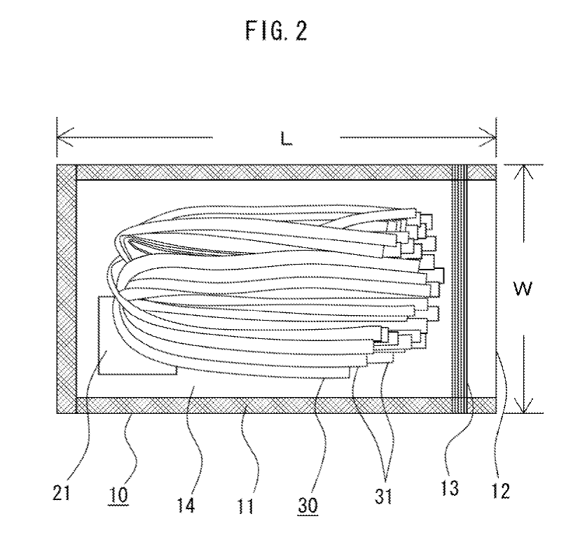

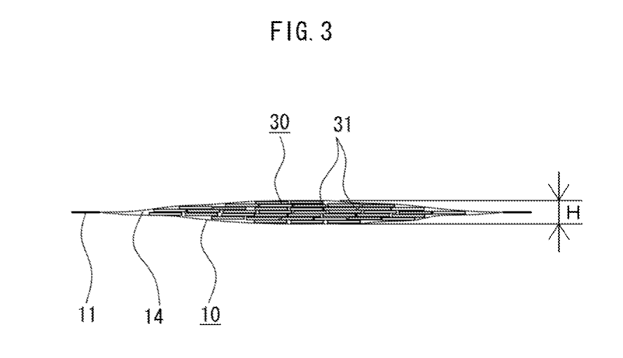

As shown in FIG. 2, the unit-length noodle strands 30 that are cut into the unit length and made into the fixed packaging shape (preferably a doubled state with an equal size of top and bottom) are individually packaged one by one by an individual packaging container 10. In the present embodiment, the packaging container 10 is a plastic container of a pouch shape having a predetermined length L and a predetermined width W. The packaging container 10 is preferably made of a retort packaging container of a pouch shape or a gas barrier film. Moreover, it is preferably made into a transparent container that is formed of a transparent plastic material to enable an interior thereof to be seen. The retort packaging container of pouch shape is made of a material suitable for heating/pressurizing/sterilizing. The retort packaging container is excellent in a heat resistance and also in a gas barrier property (having a low gas permeability) as compared with common plastic containers of pouch shape. Moreover, as shown in FIG. 2 and FIG. 3, the packaging container 10 is made of a gussetless packaging container having no gusset (thickness at the side thereof). In detail, the packaging container 10 has a sealed portion 11 formed at opposite lateral side edge parts and one longitudinal side edge part so as to be entirely sealed in an air-tight manner by a thermal welding or the like so that it has an opening 12 formed at another longitudinal side edge to allow a content to be inserted therethrough.

In the packaging step STEP 7 using the above-mentioned packaging container 10, the unit-length noodle strand 30 is inserted from the opening 12 of the pouch-shaped plastic packaging container 10 in a fixed packaging shape (preferably a doubled stage with equal top and bottom as shown in FIG. 2) and is accommodated and located in an accommodating space 14 inside the packaging container. Thereafter, the opening 12 of the packaging container 10 is sealed by a sealing apparatus to be a sealed portion 13, thereby air-tightly closing the accommodating space 14 (and the unit-length noodle strand 30 accommodated in the interior thereof) of the packaging container 10. The packaging step STEP 7 of the present embodiment does not create a vacuum in the interior of the packaging container 10 (i.e. not a vacuum packaging). Therefore, though the packaging step STEP 7 is not a vacuum packaging, when the unit-length noodle strand 30 is accommodated in the packaging container 10, the gussetless packaging container 10 is forced in itself by its resilience (to return to a flat shape), so that the container change its posture in a direction to become a flat shape for keeping its original thickness, that is, in a direction to remove the air at the interior of the packaging container 10. Thus, it is possible to make very small amount the residual air in the accommodating space 14 (in the state of accommodating the unit-length noodle strand 30) at the interior of the packaging container 10. At the same time, in the present embodiment, as shown in FIG. 2, the unit-length noodle strand 30 accommodated and located inside the packaging container 10 is made into the flat doubled packaging shape with equal top and bottom (even in the longitudinal direction of the noodle strand 31). Moreover, each of the noodle strands 31 is located in a spread and distributed manner in a planar direction (particularly in the width direction) of the accommodating space 14 of the packaging container 10 (i.e. accommodated in a flattened state by distributing in the width direction of the noodle strand 31) so that the unit-length noodle strand 30 of such packaging shape is spread in substantially an entirety of the flattened accommodating space 14 of the packaging container 10. Thereafter, the opening 12 of the packaging container 10 is sealed (packed) by the sealed portion 13 to close in a perfectly air-tight manner.

Thereby, in the accommodating space 14 of the packaging container 10, the unit-length noodle strand 30 is thinly and uniformly spread in the entire planar direction of the accommodating space 14. That is, in the packaging step STEP 7, the unit-length noodle strand 30 is accommodated in the accommodating space 14 of the packaging container 10 such that the noodle strands 31 in a folded bundle shape is spread or distributed uniformly in the width direction of the accommodating space 14 of the packaging container 10 so that the thickness formed by the layered body of the noodle strands 31 in every position of the width direction becomes substantially an equal or equivalent thin shape in every part (every position) of a primary area in the width direction, and sot that, in its longitudinal direction, it extends over substantially an entirety in the longitudinal direction of the accommodating space 14. That is, at this time, as shown in FIG. 3, the thickness dimension of the entirety of the unit-length noodle strand 30 accommodated in the accommodating space 14 of the packaging container has a thickness distribution such that it gradually decreases a little from the maximum thickness dimension H at the center part in the width direction toward the opposite ends in the width direction. Then, the thickness becomes minimum at the opposite end parts. Still, there is provided a thickness dimension that is substantially equal over the primary range (range of about 80 to 90% of the entirety) in the width direction. Moreover, the packaging mode of the thin shape of the unit-length noodle strand 30 inside the accommodating space 14 can be maintained by resilience of the gussetless packaging container 10.

A largest thickness H and a thickness distribution of the unit-length noodle strand 30 inside the accommodating space 14 is determined depending on a volume (bulk) of the unit-length noodle strand 30 and a level of thinning on the bundle-shaped noodle strands 31 of the unit-length noodle strand 30 inside the accommodating space 14 by the distribution (particularly in the width direction) of the noodle strands 31. The unit-length noodle strand 30 has a predetermined weight (e.g. 120 g, 160 g or the like) and volume, whereas each of the noodle strands 31 has a predetermined noodle strand thickness (e.g. about 1 mm) according to the pressing/extending amount in the pressing/extending step STEP 4. Consequently, the unit-length noodle strand 30 has a number of layers (number of overlaps) of the noodle strands 31, at each of the positions in the width direction in the accommodating space 14, being a number obtained by dividing the thickness at each of the positions by the noodle strand thickness of each noodle strands 31. At the portion of the largest thickness H (center portion in the width direction), it becomes a number obtained by dividing the largest thickness H by the noodle strand thickness of each noodle strand 31. The present embodiment uses a package container 10 setting its size (particularly the width of the accommodating space 14) such that the number of layers of the unit-length noodle strand 30 becomes within a predetermined number of layers, preferably within about 10 to 20 layers, more preferably about 10 to 15 layers, at the part of the largest thickness H in the above-mentioned distributed state of the unit-length noodle strand 30 in the accommodating space 14. If the number of layers of the above-mentioned unit-length noodle strand 30 in the distributed state is set within the above-mentioned predetermined number of layers at the portion of the largest thickness H, it is possible to efficiently heat each of the noodle strands 31 of the unit-length noodle strand 30 inside the packaging container 10 uniformly from an outer one to an inner one in the heating/alpha-transformation step descried later. Thus, it is possible to make each of the noodle strands 31 effectively and uniformly transformed into the alpha state and sterilized up to inner ones that are covered by outer ones of the noodle strands 31.

Moreover, the length dimension L of the packaging container 10 is set such that the length dimension of the accommodating space 14 (vertical dimension in FIG. 2) becomes larger by a little dimension than the length dimension of the doubled unit-length noodle strand 30 (distance from a folded part of the noodle strand 31 to a leading end of the noodle strand 31) so as to form a small gap between a base end (inner edge position of the sealed portion 11 opposite to the opening 12 or the left end of FIG. 2) and/or a leading end (inner edge position of the sealed portion 13 at the side of the opening 12 or the right end of FIG. 2) in the longitudinal direction of the accommodating space 14 and the folded portion and/or the leading end of the unit-length noodle strand 30. Moreover, the width dimension W of the packaging container 10 is set such that the width dimension of the accommodating space 14 (vertical dimension in FIG. 2) becomes larger by a little dimension than the width dimension of the doubled unit-length noodle strand 30 for spreading the noodle strands 31 so as to form a small gap between opposite ends in the width direction of the accommodating space 14 (inner edge positions of the opposite sealed portions 11 in the width direction or vertically opposite ends in FIG. 2) and opposite ends in the width direction of the unit-length noodle strand 30.

<Deoxidizing Step>

While the unit-length noodle strand 30 is accommodated and located in the predetermined packaging container in the packaging step, a package-like deoxidizer 21 is inserted and accommodated in the accommodating space 14 of the packaging container 10 so as to be located at one side in the thickness direction of the unit-length noodle strand 30. Then, after the opening 12 of the packaging container 10 is sealed in the packaging step STEP 7 to ensure the air-tightness by the sealed portion 13, the packaging container 10 wrapping the unit-length noodle strand 30 (i.e. packaging container containing the noodle) is left at a normal temperature for a predetermine period of time (preferably within a range of about 1 to 2 hour(s)). Thus, the oxygen in the residual air in the accommodating space 14 of the packaging container 10 in the sealing state is absorbed and removed by the deoxidizer 21, thereby being able to prevent an influence of the oxygen to the unit-length noodle strand 30 (such as prevention of microorganisms or prevention of change of quality due to oxidation or the like). Moreover, in the present embodiment, the packaging container 10 is made of the retort packaging container having low air permeability (such as oxygen permeability or the like), so that the deoxidizing treatment by the deoxidizing step STEP 8 can be conducted effectively. The air has a composition of about 78% of nitrogen and about 21% of oxygen (and the other gas of about 1%). Thus, in the deoxidizing step STEP 7, the residual air inside the accommodating space as the interior space of the packaging container 10 decreases by about 21% in case of removing the oxygen at a maximum. Where the oxygen is completely removed, only the nitrogen remains there. Thereby, the nitrogen contributes very much to prevention of oxidization of the unit-length noodle strand 30 inside the accommodating space 14. Particularly, in the heating/alpha-transformation step STEP 9 described later, when the unit-length noodle strand 30 inside the accommodating space 14 is heated via the packaging container 10 to conduct the alpha transformation and simultaneous sterilization, the air inside the accommodating space 14 is kept in a deoxidized state (state having only the nitrogen), so that it is possible to conduct the sterilization at the same time of the alpha transformation, while restraining growth of particular the aerobic microorganisms before the heating/alpha-transformation step STEP 9. Thus, an efficient sterilization is possible. Moreover, even after the heating/alpha-transformation step STEP 9, it is possible to restrain the growth of particularly the aerobic microorganisms (even if the aerobic microorganisms remain after the sterilization) inside the alpha-transformed unit-length noodle strand 30 at the interior of the accommodating space 14 of the packaging container 10 that is in the deoxidized state. The deoxidizing step may be eliminated. Even in the above-mentioned packaging step STEP 7 and the deoxidizing step STEP 8, the noodle strand is never warmed or heated at all. That is, they are carried out at a temperature range less than the alpha-transformation temperature range of the rice powder in the noodle strand (correctly a normal temperature range considerably falling below the alpha transformation temperature range). Consequently, the rice powder in the raw material is never transformed into the alpha state at all, so that the entire rice powder component is kept at the non-alpha state.

<Heating/Alpha-Transformation Step>

The unit-length noodle strand 30 in the packaging container 10 having the interior of the accommodating space 14 kept in the deoxidized state is externally heated at a prescribed heating condition by a heating apparatus. Then, at least a surface part of each of the noodle strands 31 (preferably an entire area from the surface part to an interior center part of each noodle strand 31) is heated and, at the same time, an entirety thereof is sterilized from the surface to the interior center part. In detail, a heating source of the heating apparatus may be an external heating source such as a steam heating (steam heating) or a hot air heating, and other than these, a micro wave heating or the like (from an exterior). As long as it heats uniformly each of the noodle strands 31 of the unit-length noodle strand 30 inside the packaging container 10, any heating source may be used. In case the heating apparatus uses the external heating source of the steam heating or the like as the heating source, for example, a heat energy from the heating source is applied to the unit-length noodle strand 30 inside the packaging container 10 from the exterior of the packaging container 10 that accommodates the unit-length noodle strand 30 and that is kept at the deoxidized state. Then, the unit-length noodle strand 30 is uniformly heated as a whole by heat conduction or radiation or heat convection through the air (basically the nitrogen) inside the accommodating space 14 of the packaging container 10 or a vapor made by an evaporated moisture inside the unit-length noodle strand 30 after the heating.

The heating conditions are set at optimum conditions according to the blending ratio of each material (primary raw material powder, secondary raw material powder and so on) inside the unit-length noodle strand 30, the moisture content, the kinds of the rice powder (whether white rice powder or brown rice powder), the heat resistance of the packaging container 10, the kind of germs for sterilization, the needed degree of alpha-transformation and the like. Among the heating conditions, a heating temperature is set within a temperature of about 55 degrees centigrade to about 100 degrees centigrade in the core temperature equivalent of each of the noodle strands 31 of the unit-length strand 30 inside the packaging container 10. Specifically, in case the primary raw material powder is the white rice powder, the heating temperature is set preferably within a temperature of about 55 degrees centigrade to about 95 degrees centigrade as the core temperature equivalent, more preferably within a temperature of about 60 degrees centigrade to about 93 degrees centigrade as the core temperature equivalent. In case the primary raw material powder is the brown rice powder, the heating temperature is set preferably within a temperature of about 60 degrees centigrade to about 100 degrees centigrade as the core temperature equivalent, more preferably within a temperature of about 65 degrees centigrade to about 98 degrees centigrade as the core temperature equivalent. That is, if the primary raw material powder is the brown rice powder, the heating temperature is set at a higher temperature range as compared with the case in which the primary raw material powder is the white rice powder.

Moreover, the heating time is set within a time range of about 10 minutes to about 45 minutes in case the heating source of the heating apparatus is the external heating source. Specifically, if the heating temperature is relatively high, the heating time is set relatively short, and if the heating temperature is relatively low, the heating time is set relatively long. Still, it is possible to adopt a combination of the heating temperature and the heating time as shown below according to the kind of the primary raw material powder (white rice powder or brown rice powder), for example.

<White Rice Powder>

Heating Condition No. 1 (First Low Heating Temperature Range): heating temperature of 55 degrees centigrade to 65 degrees centigrade, heating time of 40 minutes to 50 minutes (e.g. heating condition of heating temperature of 60 degrees centigrade and heating time of 45 minutes)

Heating Condition No. 2 (Second Low Heating Temperature Range): heating temperature of 60 degrees centigrade to 70 degrees centigrade, heating time of 40 minutes to 50 minutes (e.g. heating condition of heating temperature of 65 degrees centigrade and heating time of 45 minutes)

Heating Condition No. 3 (Third Low Heating Temperature Range): heating temperature of 65 degrees centigrade to 75 degrees centigrade, heating time of 40 minutes to 50 minutes (e.g. heating condition of heating temperature of 70 degrees centigrade and heating time of 45 minutes)

Heating Condition No. 4 (First Middle Heating Temperature Range): heating temperature of 70 degrees centigrade to 80 degrees centigrade, heating time of 40 minutes to 50 minutes (e.g. heating condition of heating temperature of 75 degrees centigrade and heating time of 45 minutes)

Heating Condition No. 5 (Second Middle Heating Temperature Range): heating temperature of 75 degrees centigrade to 85 degrees centigrade, heating time of 35 minutes to 45 minutes (e.g. heating condition of heating temperature of 80 degrees centigrade and heating time of 40 minutes)

Heating Condition No. 6 (Third Middle Heating Temperature Range): heating temperature of 80 degrees centigrade to 90 degrees centigrade, heating time of 35 minutes to 45 minutes (e.g. heating condition of heating temperature of 85 degrees centigrade and heating time of 40 minutes)

Heating Condition No. 7 (First High Heating Temperature Range): heating temperature of 85 degrees centigrade to 95 degrees centigrade, heating time of 35 minutes to 45 minutes (e.g. heating condition of heating temperature of 90 degrees centigrade and heating time of 40 minutes)

Heating Condition No. 8 (Second High Heating Temperature Range): heating temperature of 90 degrees centigrade to 95 degrees centigrade, heating time of 35 minutes to 45 minutes (e.g. heating condition of heating temperature of 93 degrees centigrade and heating time of 30 minutes to 40 minutes, specifically, heating condition of heating temperature of 93 degrees centigrade and heating time of 40 minutes)

Heating Condition No. 9 (Third High Heating Temperature Range): heating temperature of 90 degrees centigrade to 100 degrees centigrade, heating time of 30 minutes to 40 minutes (e.g. heating condition of heating temperature of 95 degrees centigrade and heating time of 35 minutes)

<Brown Rice Powder>

Heating Condition No. 1 (First Low Heating Temperature Range): heating temperature of 60 degrees centigrade to 70 degrees centigrade, heating time of 40 minutes to 50 minutes (e.g. heating condition of heating temperature of 65 degrees centigrade and heating time of 45 minutes)

Heating Condition No. 2 (Second Low Heating Temperature Range): heating temperature of 65 degrees centigrade to 75 degrees centigrade, heating time of 40 minutes to 50 minutes (e.g. heating condition of heating temperature of 70 degrees centigrade and heating time of 45 minutes)

Heating Condition No. 3 (Third Low Heating Temperature Range): heating temperature of 70 degrees centigrade to 80 degrees centigrade, heating time of 40 minutes to 50 minutes (e.g. heating condition of heating temperature of 75 degrees centigrade and heating time of 45 minutes)

Heating Condition No. 4 (First Middle Heating Temperature Range): heating temperature of 75 degrees centigrade to 85 degrees centigrade, heating time of 40 minutes to 50 minutes (e.g. heating condition of heating temperature of 80 degrees centigrade and heating time of 45 minutes)

Heating Condition No. 5 (Second Middle Heating Temperature Range): heating temperature of 80 degrees centigrade to 90 degrees centigrade, heating time of 35 minutes to 45 minutes (e.g. heating condition of heating temperature of 85 degrees centigrade and heating time of 40 minutes)

Heating Condition No. 6 (Third Middle Heating Temperature Range): heating temperature of 85 degrees centigrade to 95 degrees centigrade, heating time of 35 minutes to 45 minutes (e.g. heating condition of heating temperature of 90 degrees centigrade and heating time of 40 minutes)

Heating Condition No. 7 (First High Heating Temperature Range): heating temperature of 90 degrees centigrade to 95 degrees centigrade, heating time of 35 minutes to 45 minutes (e.g. heating condition of heating temperature of 95 degrees centigrade and heating time of 40 minutes)

Heating Condition No. 8 (Second High Heating Temperature Range): heating temperature of 95 degrees centigrade to 100 degrees centigrade, heating time of 35 minutes to 45 minutes (e.g. heating condition of heating temperature of 98 degrees centigrade and heating time of 30 minutes to 40 minutes, specifically, heating condition of heating temperature of 98 degrees centigrade and heating time of 40 minutes)

For example, under the heating condition at the low temperature range of the heating temperature of 60 degrees centigrade and the heating time of 45 minutes, only the surface part of the noodle strand 31 is transformed into the alpha state. Moreover, a load to the noodle strands 31 by the heating is very small. Thus, it is possible to surely prevent deterioration of quality of the noodle strands 31 by the heat and highly maintain the quality (taste or the like) of the noodle strands 31 as the noodle product. That is, the heating condition at the above-mentioned low temperature range becomes a heating condition under a relatively low temperature range or low temperature value. Thus, the rice component in the noodle strands 31 is transformed into the alpha state at a predetermined low temperature range or low temperature value (temperature near an alpha-transformation starting temperature). Consequently, it is possible to lessen a thermal influence to the noodle strands, while the sterilization effect becoming relatively small as compared with the heating condition at a high temperature range. Then, the bacterial counts remaining in the noodle strands 31 after heating become relatively high, so that a freshness date becomes relatively short. Moreover, if the temperature range of the heating condition becomes higher from the low temperature range to the middle temperature range and to the high temperature range, the sterilization effect becomes higher. Moreover, the degree of alpha-transformation of the noodle strands 31 (rate of being transformed into the alpha-state toward the core of the noodle strand 31) becomes higher. For example, under the heating condition at the high temperature range, the noodle strands 31 are transformed into the alpha state completely up to the interior center, whereas the sterilization effect can be very much improved. From a practical standpoint, a heating condition of a heating temperature of 93 degrees centigrade and a heating time of around 40 minutes is most preferable. For example, if the heating condition is set at the heating temperature of 93 degrees centigrade and a heating time of 30 minutes to 40 minutes, the noodle strands 31 of the unit-length noodle strand 30 inside the packaging container 10 are transformed into the alpha state completely up to the interior center. At the same time, each noodle strand 31 can be given a transparent feeling (like cooked rice). Thus, the heating condition at the low temperature range is preferable in terms of the quality improvement of the noodle strands, whereas the heating condition at the high temperature range is preferable in terms of the perfect alpha transformation of the noodle strands and sterilization effect. Therefore, the heating condition is appropriately set according to a variety of requirements and conditions in manufacturing the noodles.

The heating of the heating/alpha-transformation step STEP 9 is not a pressurized heating (heating at a temperature more than 100 degrees centigrade at a pressurized state more than the atmospheric pressure), so that the heating temperature never goes beyond 100 degrees centigrade. Moreover, in case the brown rice powder is used as the primary raw material powder, it is necessary to conduct sterilization at a higher temperature as compared with the white rice due to the bran powder contained in the brown rice powder. Therefore, as described above, the heating temperature is set higher than the case where the white rice powder is used. In case the heating source of the heating apparatus is the microwave heating, the heating time can be a time range from about 40 to about 60 seconds, preferably a time range from about 45 to about 55 seconds or nearly around 50 seconds (whereas the heating temperature may be set at a heating temperature similar to the above-mentioned one in the core temperature equivalent of the noodle strand).

According to the heating condition at the high temperature range, it was verified by effect confirmation tests that the sterilizing effect was obtained as follows (whereas the tests were practiced at Public Health Center of Gifu Prefecture).

Heating Condition: heating temperature of 90 degrees centigrade and heating time of 40 minutes

3 months after: bacterial counts of common bacteria being not more than 300

5 months after: bacterial counts of common bacteria being not more than 300

6 months after: bacterial counts of common bacteria being not more than 300

In the heating/alpha-transformation step STEP 9 according to the above-mentioned heating condition, the unit-length noodle strand 30 inside the packaging container 10 has a temperature of each component inside each noodle strand 31 raised by the heating. Particularly, the rice powder component raises its temperature up to a temperature not less than an alpha-transformation temperature thereof according to the heating temperature. Consequently, the rice powder component is transformed into the alpha state and, at the same time, if bacteria exist in the noodle strand 31, such bacteria are sterilized by heating.

At this time, the heat transmits from an outer one to an inner one (that is covered by the outer noodle strands 31) among the bundle-shaped noodle strands 31 of the unit-length noodle strand 30. Moreover, the heat transmits from the surface side toward the center of the interior in each noodle strand 31. Accordingly, the unit-length strand 30 inside the packaging container 10 raises the temperature from the outer noodle strand 31 to the inner noodle strand 31. Moreover, in each noodle strand 31, the temperature rises from the surface side toward the core part. Still, since the thickness is 1 mm or less, it is a time difference at a ignorable level.

Moreover, at this time, the unit-length noodle strand 30 is in the packaging state as the packaging mode inside the packaging container 10 wherein the bundle-shaped noodle strands are spread and located in a flattened shape to make the entirety into a thin flat plate shape, whereas an exposed area of the entirety becomes large. Therefore, as compared with a normal packaging mode, the number of layers of the noodle strands 31 at each part is very much lessened (about 15 layers at a maximum). Therefore, the heat conduction to the noodle strands 31 is improved, so that not only the noodle strands 31 at the outside in the thickness direction (front layer side) but also the noodle strands 31 at the inside (inner layer side) smoothly raise the temperature by heating of the heating source. Thus, the alpha-transformation and the sterilization of the rice powder component are carried out effectively.

For example, as regards the sterilization effect, in case a moist heat sterilization is conducted by use of the moisture at 55 degrees centigrade to 70 degrees centigrade as the low temperature range among the alpha-transformation temperature range of the starch component of the rice powder, among microorganisms, mycelia and spores of molds become extinct (correctly, the mycelia become extinct at the heating temperature of 60 degrees centigrade and the heating time of 2 to 3 minutes, while the spores become extinct at the heating temperature of 65 to 70 degrees centigrade and the heating time of 5 to 10 minutes), nursing cells and spores of yeasts become extinct (correctly, the nursing cells become extinct at the heating temperature of 55 to 60 degrees centigrade and the heating time of 2 to 3 minutes, while the spores become extinct at the heating temperature of 60 degrees centigrade and the heating time of 10 to 15 minutes), and nursing cells of germs become extinct (correctly, they become extinct at the heating temperature of 63 degrees centigrade and the heating time of 30 minutes). Thereby, the molds and yeasts become extinct by a relatively moderate heating condition, so that the sterilization object is mainly the germs. Still, in case of the germs, with respect to bacteria such as the common bacteria or Escherichia coli (germs other than heat resistant bacteria), most of the bacteria become extinct at the heating temperature of 55 to 75 degrees centigrade and the heating time of 10 to 30 minutes or the heating temperature of 60 to 65 degrees centigrade and the heating time of 1 to 10 minutes. In the manufacturing method of the rice powder noodle of the present invention, it is possible to conduct sterilization at a normal pressure under the heating condition of a heating temperature of 63 degrees centigrade (core temperature of the noodle strand) and the heating time of 30 minutes as one example of the heating condition in the heating/alpha-transformation step STEP 9.

In detail, vibrio parahaemolyticus becomes extinct at 65 degrees centigrade and at 5 minutes, salmonera bacteria becomes extinct at 65 degrees centigrade and at 3 minutes, enteropathogenic Escherichia coli becomes extinct at 60 degrees centigrade and at 1 minutes, nursing cells of clostridium perfringens becomes extinct at 60 degrees centigrade and at 10 minutes, campylobacter becomes extinct at 60 degrees centigrade and at 1 minutes, staphylococci becomes extinct at 65 degrees centigrade and at 1 minutes, nursing cells of botulinus bacillus type A/B becomes extinct at 65 degrees centigrade and at 10 minutes, nursing cells of botulinus bacillus type 3 becomes extinct at 65 degrees centigrade and at 10 minutes, and even spores of botulinus bacillus type E becomes extinct at 80 degrees centigrade and at 3 minutes. That is, among the alpha-transformation temperature ranges of the starch component of the rice powder, it is possible to make most of the bacteria extinct at the temperature range of 60 to 65 degrees centigrade that is a preferred temperature range in the low temperature range. At 80 degrees centigrade to 90 degrees centigrade as a preferred temperature range in the high temperature range (75 to 95 degrees centigrade), it is possible to make even the spores of the botulinus bacillus type E extinct. Thus, most of the common bacterial and the Escherichia coli become extinct at the heating temperature of 60 to 65 degrees centigrade and the heating time of 1 to 10 minutes.

On the other hand, as a heating temperature that has a lowest-impact on the noodle (i.e. that does not deteriorate the quality such as taste or the like), as described above, it is preferable to choose the temperature range (heating time of about 45 minutes) around 65 degrees centigrade at the center temperature (core temperature) of the noodle strand. Even in this case, it is possible to make most of the germs extinct (since most of the germs among the kinds of germs become extinct at the temperature of about 60 degrees centigrade) without hardly having an influence on the quality of the noodle, thereby being able to satisfy the sanitary standard for foods (food sanitary management standard of HACCP or the like).

In the conventional manufacturing method of the long-life noodle of the wheat flour noodle or the rice powder noodle, the kneaded body or the noodle dough sheet or the noodle strand is heated once by the hot water kneading or the steam kneading or the boiling treatment to make it into alpha-state before packaging the unit-length noodle strand, so that the raw material becomes at a high temperature by the heat at that time. Thus, it is necessary to cool the kneading body or the noodle dough sheet or the noodle strand before the packaging. Particularly, it is preferable to rest the noodle dough sheet after forming the noodle dough sheet even in the wheat flour noodle produced by the common noodle manufacturing method. Consequently, a cooling step or a resting step therefor is needed for a considerable time period, thereby prolonging the production time and possibly causing the germs to grow inside the kneaded substance or the noodle dough sheet or the noodle strand. Moreover, in case the rice powder component is transformed into the alpha state by the steam kneading or the line to form the kneaded substance in the conventional manufacturing method of the rice powder noodle, if the kneaded substance is too cooled, the kneaded substance becomes stiff and causes a trouble in forming the noodle strands in the next extrusion step. Thus, the temperature management therefor is needed, too. In the shaping of the noodle strands by the extrusion, the surface of the extruded noodle strand is heated at a surface of a die and receives a thermal influence thereof due to a friction heat by a pressure when the raw material is extruded from the die of the extruding machine. Consequently, such thermal influence needs to be managed in a strict sense.

By contrast, in the present invention, the cooling step and the resting step are unnecessary. Thus, it is possible to shorten the production time by a large degree. Moreover, the formation from the kneaded substance and the noodle dough sheet to the noodle strands can be conducted in a short time as a sequence of successive steps (sequence of steps in which the work is not interrupted by the cooling or the like in mid-flow). Consequently, it is possible to restrain the growth of the germs to a large extent at the inside of the kneaded substance or the noodle dough sheet or the noodle strands.

Moreover, the conventional noodle that is boiled or the like has a high moisture content, so that there is a condition where the germs are easy to grow in the cooling step or the like. By contrast, in the present invention, the noodle strands formed in the above-mentioned sequence of steps has a largely lessened moisture content as compared with the noodle that is boiled or the like. Consequently, there is a condition where the germs or the like are hard to grow. Moreover, as described above, the sequence of steps are finished in a short time, and just thereafter, the packaging is carried out in the packaging step. Therefore, the noodle is shielded from an externality and it is possible to surely prevent intrusion of germs by their dropping or sticking or the like. Moreover, since the air inside the packaging container is deoxidized by the deoxidizer so as to provide the environment where the germs (aerobic bacteria) cannot grow, the growth of the germs can be restrained revolutionarily. Furthermore, the sterilization by the heating/alpha-transformation step STEP 9 is carried out at such state, so that the residual germs can be surely sterilized.

The packaged noodle product manufacture by the above-mentioned manufacturing method is able to be preserved one year or more by the preservation at a normal temperature. Even in this case, it is possible to ensure a sanitary condition of 300 or less of the common germs (it has been confirmed by examination by verification tests that a long storage quality could be ensured such that the number of germs became 300 or less after 22 months after production).

In addition, the packaged noodle product made by the above-mentioned manufacturing method increases the binding force between the components by transforming the rice powder component into the alpha state at least the its surface part. Thus, the noodle strand 31 are hard to break in the packaging container 10 and when taking out the noodle strands 31 by opening the packaging container 10 or when handling them for cooking after taking out. Moreover, with respect to the packaged noodle powder noodle after production, the noodle strand 31 has at least the surface part made into the alpha state. Consequently, when opening the packaging container 10 for eating, the noodle strands 31 come into a state for eating only by soaking the noodle strands 31 in a hot water at a high temperature for a predetermine time period (about several minutes). That is, even in case of the noodle strands 31 with the interior core part in the non-alpha state, the non-alpha part is easily made into the alpha state by the heat conductance from the hot water of the high temperature, so that the noodle strand 31 is made into the alpha state as a whole. Thus, the noodle can be eaten without the boiling treatment. As a matter of course, in case of the noodle strands 31 having the entirety including the interior core part made in the alpha state, the noodle can be eaten without the boiling treatment in a shorter time period. Moreover, at this time, since at least the surface part of the noodle strand 31 is in the alpha state, it is possible to prevent a so-called hot water contamination (white turbidity or the like of the hot water by eluted component from the surface of the noodle strand 31). Thus, according to the above-mentioned manufacturing method of the rice powder noodle, it is possible to manufacture the noodle product wherein only the surface part of the noodle is made into the alpha state. In this case, in addition that the noodle becomes a tasty noodle, the quality of the noodle strand can be improved other than the taste. On the other hand, even at the low temperature range of the heating temperature of about 60 degrees centigrade, as described above, the number of the germs can be reduced to the extent causing no problem. Still, using the heating condition at the high temperature range, the powder component can be made into the alpha state up to the core part of the noodle strand and the sterilization effect of the germs can be improved largely.

Moreover, according to the above-mentioned manufacturing method of the rice powder noodle, since the unit-length noodle strand 30 is accommodated in a thin flat plate shape in the packaging container 10, as compared with the case where the noodle is accommodated in a ball shape as in the common packaged noodle product, the alpha-transformation and the sterilization can be conducted very efficiently by heating, while the alpha-transformation and the sterilization can be conducted surely on the noodle strands 31 at the inner layer side among the bundle-shaped noodle strands. In detail, in the above-mentioned manufacturing method of the rice powder noodle, where the above-mentioned packaging mode is adopted as the packaging mode of the unit-length strand 30 inside the packaging container 10, the unit-length strand 30 inside the accommodating space 14 of the packaging container 10 is packaged in a packaging mode wherein the rate regulated by the lateral dimension (horizontal dimension inside the accommodating space 14) and the thickness dimension (referred to as “flatness rate” for convenience of explanation) becomes such that the flatness rate=(lateral dimension−thickness dimension)/lateral dimension=about 70% to 85%. Thereby, in the above-mentioned heating/alpha-transformation step STEP 9, the unit-length noodle strand 30 inside the accommodating space 14 of the packaging container 10 has not only the outer noodle strands 31 but also the inner noodle strands 31 heated in a uniform and even manner and in an efficient way so that it raises the temperature even of the interior of each noodle strand 31. Thus, the above-mentioned alpha-transformation of the rice powder component is smoothly realized and the sterilization is simultaneously realized effectively. The rice powder component made into the alpha state as described above maintains the alpha state ever after cooling of the unit-length noodle strand 30.

<Cooling Step>

The packaged noodle product that has the unit-length noodle strand 30 inside the packaging container 10 made into the alpha state in the above-mentioned heating/alpha-transformation step STEP 9 is cooled to a normal temperature thereafter and then handled appropriately such as a packing or the like. In the above-mentioned heating/alpha-transformation step STEP 9, the moisture inside the unit-length noodle strand at the interior of the packaging container 10 may evaporate inside the packaging container 10 to make condensation at the inside of the packaging container 10. Still, the water vapor and the dew condensation at this time are absorbed in the interior of the noodle strands 31 of the unit-length noodle strand 30 again in the cooling step to return the moisture content inside the unit-length noodle strand 30 to its original state. Thus, the dew condensation inside the packaging container 10 disappears.

### First Working Example

### Working Example of Packaging Mode

As the packaging mode of the unit-length noodle strand in the packaging step of the above-mentioned embodiment, for example, the following packaging modes can be adopted according to the kind of the noodle product.

<Rice Powder Kishimen>

Rice Powder Kishimen

Weight (noodle) being nearly equal to 120 g

Weight (noodle plus packaging container) being nearly equal to 127.5 g (package being nearly equal to 7.5 g)

Length of Packaging Container being nearly equal to 22.5 cm

Width of Packaging Container being nearly equal to 13.0 cm

Length of Accommodating Space being nearly equal to 19.5 cm

Width of Accommodating Space being nearly equal to 11.0 cm

Length of Unit-Length Noodle Strand being nearly equal to 18.0 cm

Width of Unit-Length Noodle Strand being nearly equal to 8.7 cm

Maximum Thickness of Unit-Length Noodle Strand (folded/bent part of noodle strands) being nearly equal to 1.5 cm

Minimum Thickness of Unit-Length Noodle Strand (folded/bent part of noodle strands) being nearly equal to about ½ of 1.5 cm

Number of Noodle Strand Layers at Maximum Thickness Part being nearly equal to 15 layers

Flatness Rate being nearly equal to 83%

<Rice Powder Udon>

Weight (noodle) being nearly equal to 120 g

Weight (noodle plus packaging container) being nearly equal to 132.5 g (package being nearly equal to 12.5 g)

Length of Packaging Container being nearly equal to 22.5 cm

Width of Packaging Container being nearly equal to 13.0 cm

Length of Accommodating Space being nearly equal to 19.5 cm

Width of Accommodating Space being nearly equal to 11.0 cm

Length of Unit-Length Noodle Strand being nearly equal to 16.5 cm

Width of Unit-Length Noodle Strand being nearly equal to 9.1 cm

Maximum Thickness of Unit-Length Noodle Strand (folded/bent part of noodle strands) being nearly equal to 2.2 cm

Number of Noodle Strand Layers at Maximum Thickness Part being nearly equal to 22 layers

Flatness Rate being nearly equal to 75%

<Rice Powder Ramen>

Weight (noodle) being nearly equal to 120 g

Weight (noodle plus packaging container) being nearly equal to 135 g (package being nearly equal to 15 g)

Length of Packaging Container being nearly equal to 22.5 cm

Width of Packaging Container being nearly equal to 13.0 cm

Length of Accommodating Space being nearly equal to 19.5 cm

Width of Accommodating Space being nearly equal to 11.0 cm

Length of Unit-Length Noodle Strand being nearly equal to 17.0 cm

Width of Unit-Length Noodle Strand being nearly equal to 7.0 cm

Maximum Thickness of Unit-Length Noodle Strand (folded/bent part of noodle strands) being nearly equal to 2 cm

Number of Noodle Strand Layers at Maximum Thickness Part being nearly equal to 20 layers

Flatness Rate being nearly equal to 71%

<Rice Powder Spaghetti>

Weight (noodle) being nearly equal to 160 g

Weight (noodle plus packaging container) being nearly equal to 170 g (package being nearly equal to 10 g)

Length of Packaging Container being nearly equal to 22.5 cm

Width of Packaging Container being nearly equal to 13.5 cm

Length of Accommodating Space being nearly equal to 19.5 cm

Width of Accommodating Space being nearly equal to 11.5 cm

Length of Unit-Length Noodle Strand being nearly equal to 17.0 cm

Width of Unit-Length Noodle Strand being nearly equal to 8.5 cm

Maximum Thickness of Unit-Length Noodle Strand (folded/bent part of noodle strands) being nearly equal to 2.4 cm

Number of Noodle Strand Layers at Maximum Thickness Part being nearly equal to 24 layers

Flatness Rate being nearly equal to 72%

<Rice Powder Fresh Pasta>

Weight (noodle) being nearly equal to 120 g

Weight (noodle plus packaging container) being nearly equal to 137.5 g (package being nearly equal to 7.5 g)

Length of Packaging Container being nearly equal to 22.5 cm

Width of Packaging Container being nearly equal to 13.0 cm

Length of Accommodating Space being nearly equal to 19.5 cm

Width of Accommodating Space being nearly equal to 11.0 cm

Length of Unit-Length Noodle Strand being nearly equal to 17.5 cm

Width of Unit-Length Noodle Strand being nearly equal to 7.7 cm

Maximum Thickness of Unit-Length Noodle Strand (folded/bent part of noodle strands) being nearly equal to 2 cm

Number of Noodle Strand Layers at Maximum Thickness Part being nearly equal to 20 layers

Flatness Rate being nearly equal to 74%

<Rice Powder Fresh Pasta (Brown Rice)>

Weight (noodle) being nearly equal to 120 g

Weight (noodle plus packaging container) being nearly equal to 137.5 g (package being nearly equal to 7.5 g)

Length of Packaging Container being nearly equal to 22.5 cm

Width of Packaging Container being nearly equal to 13.0 cm

Length of Accommodating Space being nearly equal to 19.5 cm

Width of Accommodating Space being nearly equal to 11.0 cm

Length of Unit-Length Noodle Strand being nearly equal to 17.5 cm

Width of Unit-Length Noodle Strand being nearly equal to 7.6 cm

Maximum Thickness of Unit-Length Noodle Strand (folded/bent part of noodle strands) being nearly equal to 2.3 cm

Number of Noodle Strand Layers at Maximum Thickness Part being nearly equal to 23 layers

Flatness Rate being nearly equal to 70%

### Second Embodiment

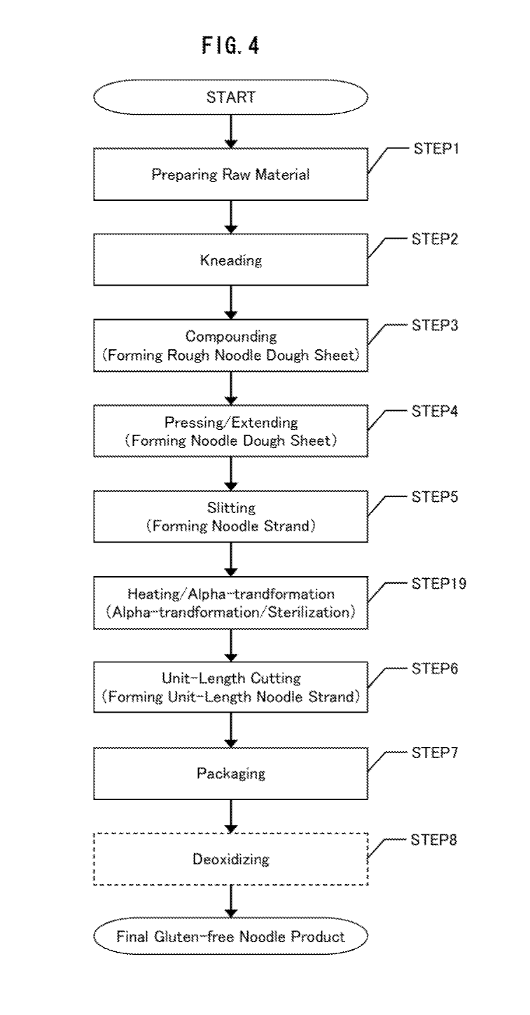

The manufacturing method of the rice powder noodle according to the second embodiment of the present invention is described hereafter referring to FIG. 4. As shown in FIG. 4, the manufacturing method of the rice powder noodle according to the second embodiment has a sequence or group of steps of the raw material preparing step STEP 1, the kneading step STEP 2, the compounding step (rough noodle dough sheet forming step) STEP 3, the pressing/extending step (noodle rough sheet forming step) STEP 4, the slitting step (noodle strand forming step) STEP 5, the unit-length cutting step (unit-length noodle strand forming step) STEP 6, the packaging step STEP 7, the deoxidizing step STEP 8 and a heating/alpha-transformation step (alpha-transformation/sterilizing step) STEP 19. The deoxidizing step STEP 8 may be eliminated (even in the first embodiment, the deoxidizing step STEP 8 may be eliminated).

On the other hand, in the manufacturing method of the rice powder noodle according to the second embodiment, the heating/alpha-transformation step STEP 19 is conducted just after the slitting step (noodle strand forming step) STEP 5 and just before the unit-length cutting step STEP 6 (i.e. between the slitting step STEP 5 and j the unit-length cutting step STEP 6). Thus, as compared with the first embodiment, particularly in case of mass-production of the rice powder noodle, the starch at the surface and at the interior of the noodle strand can be efficiently heated and rapidly made into the alpha state by directly heating the noodle strands (that are on a conveying apparatus such as a belt conveyor or the like before packaging), thereby largely improving the productivity. That is, at this time, the noodle strands are arranged into a single layer (i.e. a plurality of layers of noodle strands being not overlapped in the thickness direction) and laid on a conveying plane of the conveying apparatus and move in a conveying direction. Therefore, it is possible to heat the single layer of the noodle strands in a short time period in a very efficient way by a predetermined external heating apparatus (such as a moist heating apparatus using a steam heating, a dry heating apparatus using a hot-air heating, micro wave heating apparatus or the like), thereby carrying out very efficiently and rapidly the alpha transformation of the starch component that is to be the binding component at the inside.

<Slitting Step>

In the second embodiment, the noodle strands formed in the pressing/extending step STEP 4 is supplied to the slitting apparatus in the slitting step (noodle strand forming step) STEP 5 as in the first embodiment. Then, it is slit into a predetermined noodle strand shape (noodle strand shape of the same predetermined noodle strand width as the final noodle product).

<Heating/Alpha-Transformation Step>

The noodle strand formed in the slitting step STEP 5 is externally heated at a prescribed heating condition by a heating apparatus in the heating/alpha-transformation step STEP 19. Then, at least a surface part of the noodle strand (preferably an entire area from the surface part to an interior center part of each noodle strand) is heated and, at the same time, an entirety thereof is sterilized from the surface to the interior center part. In detail, a heating source of the heating apparatus may be an external heating source such as a steam heating (steam heating) or a hot air heating, and other than these, a micro wave heating or the like (from an exterior), as in the first embodiment. As long as it heats uniformly each of the noodle strands, any heating source may be used. That is, for the heating in this case, any heating/alpha-transformation step may be used as long as it make the rice powder component at least at the surface part of each of the noodle strands of the continuous noodle strand in the packaging container and simultaneously sterilizing the germs inside each of the noodle strands of the continuous noodle strand by uniformly heating by the dry heating from the exterior carried out through only the moisture container inside the continuous noodle strand or by the moist heating from the exterior.

In the same manner as the first embodiment, the heating conditions are set at optimum conditions according to the blending ratio of each material (primary raw material powder, secondary raw material powder and so on) inside the unit-length noodle strand 30, the moisture content, the kinds of the rice powder (whether white rice powder or brown rice powder), the kind of germs for sterilization, the needed degree of alpha-transformation and the like. Among the heating conditions, a heating temperature is set within a temperature of about 55 degrees centigrade to about 100 degrees centigrade in the core temperature equivalent of the noodle strand. Specifically, in case the primary raw material powder is the white rice powder, the heating temperature is set preferably within a temperature of about 55 degrees centigrade to about 95 degrees centigrade as the core temperature equivalent, more preferably within a temperature of about 60 degrees centigrade to about 93 degrees centigrade as the core temperature equivalent. In case the primary raw material powder is the brown rice powder, the heating temperature is set preferably within a temperature of about 60 degrees centigrade to about 100 degrees centigrade as the core temperature equivalent, more preferably within a temperature of about 65 degrees centigrade to about 98 degrees centigrade as the core temperature equivalent. That is, if the primary raw material powder is the brown rice powder, the heating temperature is set at a higher temperature range as compared with the case in which the primary raw material powder is the white rice powder.

Moreover, the heating time is set shorter than the heating time of the first embodiment in case the heating source of the heating apparatus is an external heating source, e.g. within a time range of about 1 minute to about 20 minutes or preferably about 5 minutes to about 10 minutes. Specifically, if the heating temperature is relatively high, the heating time is set relatively short, and if the heating temperature is relatively low, the heating time is set relatively long. Still, it is possible to adopt a combination of the heating temperature and the heating time as shown below according to the kind of the primary raw material powder (white rice powder or brown rice powder), for example.

In the heating/alpha-transformation step STEP 19 according to the above-mentioned heating condition, the noodle strands (because of being not folded as in the case of the first embodiment and forming the single layer) has a temperature of each component inside the noodle strand raised rapidly by the heating. Particularly, the rice powder component raises rapidly its temperature up to a temperature not less than an alpha-transformation temperature thereof according to the heating temperature. Consequently, the rice powder component is transformed rapidly into the alpha state and, at the same time, if bacteria exist in the noodle strand, such bacteria are sterilized by heating.

At this time, the noodle strands are arranged to be distributed in a flat shape in the single layer manner so as to become a very thin flat plate shape (consisting only of one layer) as a whole, while the entirety of the front and rear surfaces of the noodle strands being exposed. Consequently, as compared with the unit-length noodle strand (consisting of folded plural layers) made into the packaging mode of the first embodiment, the heat conduction efficiency to the noodle strands improves. Therefore, the noodle strands can be heated to raise the temperature still more smoothly by heating of the heating source. Thus, the alpha-transformation and the sterilization of the rice powder component are carried out still more effectively.

On the other hand, as a heating temperature that has a lowest-impact on the noodle (i.e. that does not deteriorate the quality such as taste or the like), as in the first embodiment, it is preferable to choose the temperature range (heating time of about 45 minutes) around 65 degrees centigrade at the center temperature (core temperature) of the noodle strand. Even in this case, it is possible to make most of the germs extinct (since most of the germs among the kinds of germs become extinct at the temperature of about 60 degrees centigrade) without hardly having an influence on the quality of the noodle, thereby being able to satisfy the sanitary standard for foods (food sanitary management standard of HACCP or the like).

The noodle strands made into the alpha state in the above-mentioned heating/alpha-transformation step STEP 19 is supplied to the unit-length cutting apparatus in the unit-length cutting step STEP 6, in the same manner as the first embodiment. Then, it is cut into a fixed length (same length as each noodle strand length of the final noodle product) to be a unit-length noodle strand, and is thereafter arranged into a predetermined packaging shape (preferably double-folded with a top and bottom of a same length).

<Cooling Step>

The unit-length noodle strand 30 made into the alpha state in the above-mentioned heating/alpha-transformation step STEP 19 is cooled to a normal temperature thereafter by a natural cooling or the like.

In the second embodiment, as shown in FIG. 2, the unit-length noodle strands 30 that are cut into the unit length and made into the fixed packaging shape (preferably a doubled state with an equal size of top and bottom) are individually packaged one by one by an individual packaging container 10. As the packaging container 10, similar ones to the first embodiment may be used. In the second embodiment (and in the first embodiment), as the packaging mode by the packaging container, a packaging mode by an ordinary plastic packaging container (having relatively low sealing capacity and ensuring air permeability with an outside to a certain degree as compare with a vacuum packaging container) other than the vacuum packaging by the retort packaging container or the gas barrier film.

The heating/alpha-transformation step STEP 19 may be conducted not between the slitting step STEP 5 and the unit-length cutting step STEP 6 but just after the unit-length cutting step (unit-length noodle strand forming step) STEP 6 (i.e. between the unit-length cutting step STEP 6 and the packaging step STEP 7). In this case, if the noodle strands are folded into a plurality of layers after the unit-length cutting step, the heating efficiency lowers as compared with the case where the heating/alpha-transformation step STEP 19 is conducted between the slitting step STEP 5 and the unit-length cutting step STEP 6. Still, as compared with the first embodiment, it is possible to heat the starch at the surface and the interior of the noodle strand in still more efficient way to make it into the alpha state rapidly and uniformly, thereby being able to improve the productivity still more largely.

### Third Embodiment

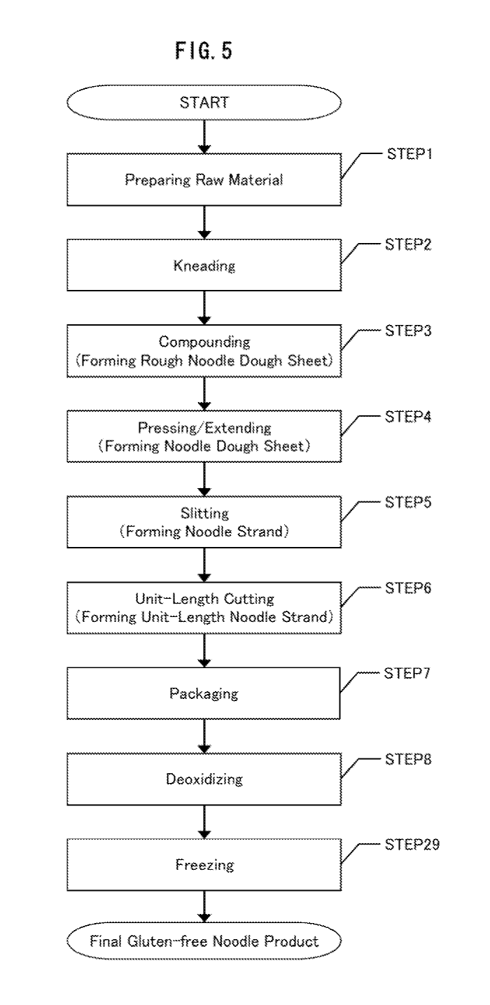

The manufacturing method of the rice powder noodle according to the third embodiment of the present invention is described hereafter referring to FIG. 5. As shown in FIG. 5, in the same manner as the first embodiment, the manufacturing method of the rice powder noodle according to the third embodiment has a sequence of steps of the raw material preparing step STEP 1, the kneading step STEP 2, the compounding step (rough noodle dough sheet forming step) STEP 3, the pressing/extending step (noodle rough sheet forming step) STEP 4, the slitting step (noodle strand forming step) STEP 5, the unit-length cutting step (unit-length noodle strand forming step) STEP 6, the packaging step STEP 7, and the deoxidizing step STEPS. The deoxidizing step STEP 8 may be eliminated. On the other hand, the manufacturing method of the rice powder noodle according to the third embodiment is different from the first embodiment and the second embodiment in that it does not conduct the heating/alpha-transformation step (alpha-transformation/sterilizing step) STEP 9 or STEP 19.

That is, in the third embodiment, the unit-length noodle strand 30 is packaged by the packaging container 10 in the above-mentioned packaging step STEP 7 (and the deoxidizing step STEP 8 as needed). Thereafter, the packaged noodle product composed of the packaged unit-length noodle strand (rice powder noodle in a so called fresh noodle state) is made into a frozen state of a fixed temperature by a predetermined freezing apparatus as it is (without passing the heating/alpha-transformation step STEP 9). Then, it is processed by an appropriate packing or the like by a predetermined packing container or the like and shipped. The above-mentioned packaging step STEP 7 and the deoxidizing step STEP 8 do not warm or heat the noodle strands at all as in the first embodiment. They are carried out at a temperature less than the alpha-transformation temperature of the rice powder inside the noodle strand. Thus, the rice powder in the raw material is never made into the alpha state at all and the entire rice component is kept at the non-alpha state. That is, the rice powder noodle produced by the manufacturing method of the first embodiment and the second embodiment is (not a fresh noodle having the rice powder as the primary raw material powder not made into the alpha state at all) but the fresh-type rice powder noodle wherein the starch component of the rice powder is made into the alpha state to a certain degree (i.e. to a degree necessary to exert the binding effect). By contrast, the rice powder noodle produced by the manufacturing method of the third embodiment becomes a fresh noodle having the rice powder as the primary raw material powder not made into the alpha state at all.

According to the manufacturing method of the rice powder noodle as the fresh noodle of the third embodiment, the noodle strand is never externally heated under the predetermined heating condition by the heating apparatus by the heating/alpha-transformation step STEP 9. Consequently, it is not necessary to conduct the cooling to the normal temperature after the heating/alpha-transformation step STEP 9 or STEP 19, thereby making the cooling step unnecessary so as to improve the productivity by that amount. Moreover, in the third embodiment, after the unit-length noodle strand 30 is packaged in the packaging container 10 in the packaging step STEP 7 and the deoxidizing step STEP 8, it can be frozen as it is. Thus, it is possible to eliminate the production time in the heating/alpha-transformation step STEP 9 or STEP 19 and the cooling step thereafter, thereby being able to largely shorten the production time. Furthermore, though the rice powder noodle of the third embodiment has the rice powder to be the binding component not made into the alpha state, it is frozen at a predetermined freezing temperature just after the packaging step and kept in a solidified state so as to maintain its noodle strand shape. Therefore, the noodle strand shape hardly deforms inside the packaging container during transportation or at the time of storage or the like, so that it is able to ensure the preservative property over a long period of time. Moreover, when cooking, the rice powder noodle is taken out of the packaging container and heated to be cooked just after being thawed so that it is possible to cook while keeping its noodle strand shape. Thus, even though the rice powder component to be the binding component is not made into the alpha state, it can ensure the noodle quality same as the first embodiment and the second embodiment.

### Corn Powder Noodle

The manufacturing method of the gluten-free noodle according to the present invention can be embodied in a “manufacturing method of a corn powder noodle” that uses only a corn powder as the primary raw material powder (i.e. the primary raw material powder consisting of 100% corn powder) other than embodying into the “manufacturing method of the rice powder noodle” that uses the rice powder as the primary raw material powder as described above. In this case, for example, the corn powder noodle can be manufacture by the steps similar to those of the manufacturing method of the rice powder noodle shown in FIG. 1, FIG. 4 and FIG. 5, using raw materials (secondary raw material powder, additive such as thickener or polysaccharide thickener) similar to that of the above-mentioned rice powder noodle and making the kinds of each of the raw materials and the blending ratio same as the case of the rice powder noodle, that is, in the same manufacturing condition as the rice powder noodle. Specifically, for example, as the corn powder as the primary raw material powder, the ones having the same particle size range as the above-mentioned rice powder noodle of the primary raw material powder. Moreover, as the secondary raw material powder, it is possible to use an alpha starch or the like. However, if an alpha grit having 100% corn material is used as the secondary raw material powder, it is possible to produce a corn powder noodle of 100% corn component (with respect to the primary raw material powder and the secondary raw material powder). The manufacturing method of the corn powder noodle exerts the same functions and effects as the above-mentioned manufacturing method of the rice powder noodle. That is, the manufacturing method of the gluten-free noodle of the present invention can use the corn powder other than the rice powder as the primary raw material powder. Moreover, other than these, it can use a primary raw material powder in a fine powder state that has functional groups on the surface activated by micro-pulverizing a gluten-free cereal such as a Japanese millet, a foxtail millet, a proso millet in a predetermined particle size range.

### Packaging Mode of Noodle

In the manufacturing method of the gluten-free noodle according to the present invention, a wide variety of packaging mode is applicable other than the above-mentioned packaging mode of the noodle. For example, such packaging may be used as a three-side seal packaging, a pillow packaging (packaging mode that seals at a center sealing portion and an end sealing portion) or the like. Thereby, the unit-length noodle strand cut into a fixed length (same length as the length of each noodle strand of the final noodle product) in the unit-length cutting step STEP 6 are individually packaged one by one by an individual packaging container in the packaging step STEP 7 as keeping its original shape (linear state just after being made into the unit-length noodle strand by cutting the noodle strand) without reshaping into a predetermined packaging mode.

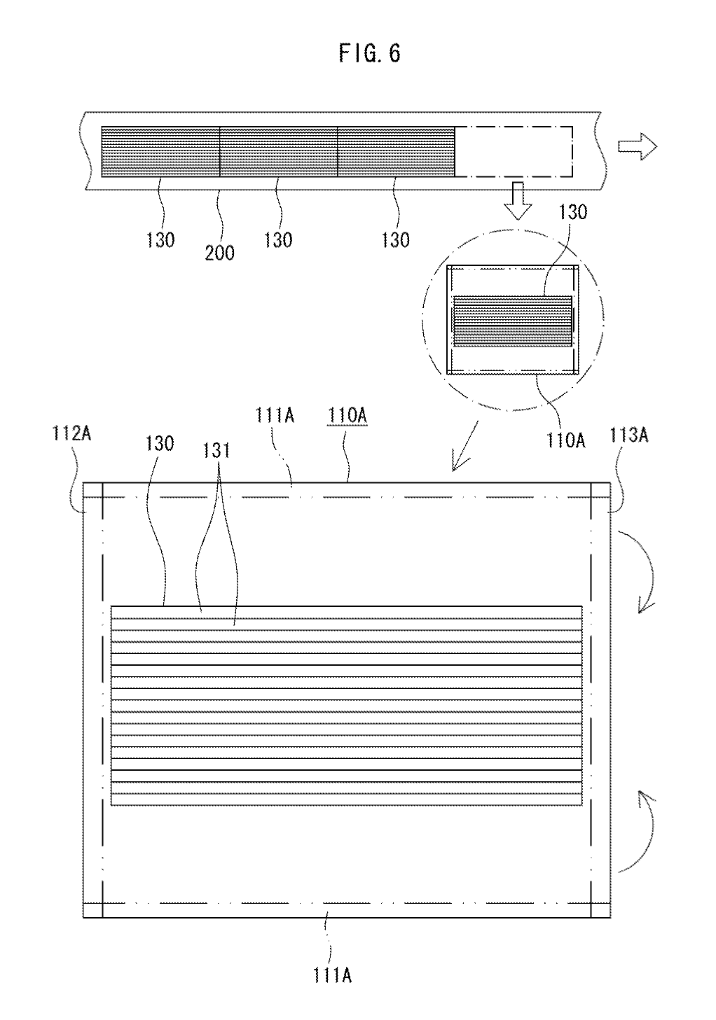

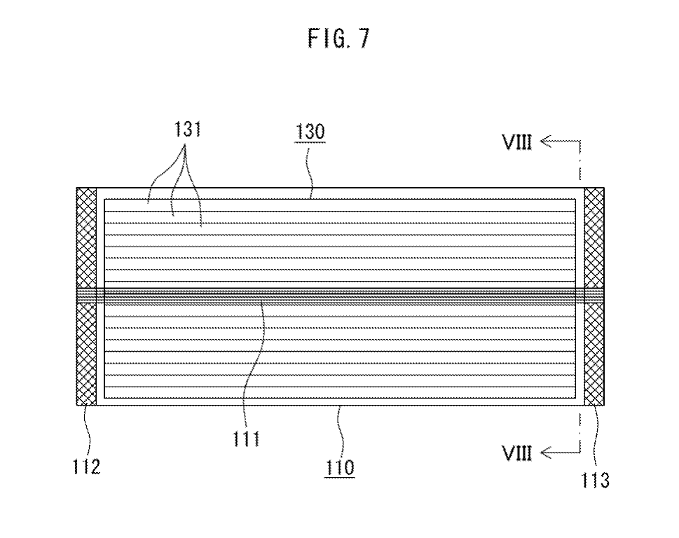

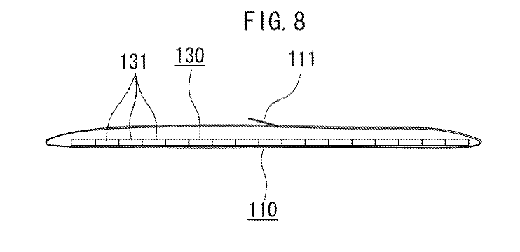

For example, as shown in FIG. 6, individual unit-length noodle strand 130 (collection of noodle strands 131) (composed of many noodle strands 131 of the unit-length noodle strand length) that is formed in the unit-length cutting step is laid on a conveying plane of a conveying apparatus such as a belt conveyor and conveyed in a predetermined conveying direction while keeping the shape of the noodle strands 131 in the linear state that is the state just after cutting. Then, each unit-length noodle strand 130 is packaged by a predetermined packaging film 110 in a predetermined packaging mode, while keeping the linear state as it is. As the packaging mode in this case, for example, as shown in FIG. 7 to FIG. 8, the unit-length noodle strand 130 is laid on a center part of one side surface of a rectangular raw material film 110A while keeping its linear state. Then, a pair of center sealing edge portions 111A at opposite edge portions in the width direction of the raw material film 110A are welded (sealed) with each other to form a center seal portion 111, whereas end sealing edge portions 112A and 113A at opposite edge portions in the longitudinal direction of the raw material film 110A are welded (sealed) respectively to form end seal portions 112 and 113. Thereby, it is possible to produce a packaged noodle product that accommodates the unit-length noodle product 130 at the inside of the packaging container 110 in a predetermined arranging mode.

As described above, in the present invention, in case of packaging the unit-length noodle strand in the packaging container, as shown in FIG. 2, the unit-length noodle strand 30 may be accommodated in a doubled state (made into plural layered state such as double layered state or the like). Alternatively, as shown in FIG. 7 to FIG. 8, a unit-length noodle strand 130 may be accommodated in the single layer state (without being folded). That is, the packaging mode of the unit-length noodle strand may be changed appropriately.

The manufacturing method of the rice powder noodle according to the present invention is applicable to a wide variety of packaged noodle products.

The preferred embodiments described herein are illustrative and not restrictive, the scope of the invention being indicated in the appended claims and all variations which come within the meaning of the claims are intended to be embraced therein.

1. A manufacturing method of a fresh-type rice powder noodle that uses a raw material containing only a rice powder as a primary raw material powder and that manufactures the rice powder noodle by a common noodle manufacturing process,
characterized by comprising:
a raw material preparing step for adding a water to a rice powder as a primary raw material powder to prepare a mixed raw material, while maintaining a non-alpha state of a rice powder component in the mixed raw material,
a kneading step for kneading the mixed raw material is to form a kneaded substance, while maintaining a non-alpha state of the rice powder component in the kneaded substance,
a pressing/extending step for pressing and extending the kneaded substance to form a noodle dough sheet, while maintaining a non-alpha state of the rice powder component in the noodle dough sheet,
a slitting step for slitting the noodle dough sheet into a predetermined noodle strand shape to obtain a continuous noodle strand, while maintaining a non-alpha state of the rice powder component in the continuous noodle strand,
a unit-length cutting step for cutting the continuous noodle strand into a predetermined length to obtain individual unit-length noodle strands, while maintaining a non-alpha state of the rice powder component in the unit-length noodle strand,
a packaging step for accommodating and hermetically sealing the unit-length noodle strand in a pouch-like heat-resistant packaging container to obtain a packaged unit-length noodle strand, while maintaining a non-alpha state of the rice powder component in the noodle strand, and
a heating/alpha-transformation step for uniformly heating the unit-length noodle strand inside the packaging container only once at a temperature not less than a predetermined temperature, at which the rice powder component in the unit-length noodle strand comes into an alpha state, via a water component in the unit-length noodle strand inside the packaging container, thereby transforming the rice powder component at least at a surface part of each noodle strand of the unit-length noodle strand inside the packaging container and simultaneously sterilizing germs in the unit-length noodle strands, as an alpha transformation to increase a binding/fixing force as a binding effect between the mutual rice powder components at least at the surface part of each noodle strand of the unit-length noodle strand.

2. A manufacturing method of a rice powder noodle as recited in claim 1, characterized further in that, after the unit-length noodle strand is accommodated inside the packaging container in the packaging step, a deoxidizer is accommodated inside the packaging container, and the packaging container is hermetically sealed and then is left for a predetermined time period to deoxidize an accommodating space inside the accommodating container by the deoxidizer, and thereafter the unit-length noodle strand inside the packaging container is heated in the heating/alpha-transformation step to make the unit-length noodle strand made into the alpha-state only once.

3. A manufacturing method of a rice powder noodle as recited in claim 1, characterized in that, in the packaging step, the packaging container is made or a gussetless packaging container having a flat pouch shape without gusset, the unit-length noodle strand is inserted from an opening at one end inside the gusseless packaging container into an interior of the accommodating space and accommodated and located in the accommodating space in a packaging mode where the unit-length noodle strand is made into a doubled state equally in a longitudinal direction of the noodle strands and spread in a width direction of the noodle strands into a flattened state and where a thickness of every part in an entire width direction becomes an even thin shape over a primary area in the width direction, then the opening of the packaging container is sealed to be closed so that the packaging container is urged into a flat shape by using a resilience of the gussetless packaging container itself so as to maintain the packaging mode of the thin shape of the unit-length noodle strand inside the accommodating space.

4. A manufacturing method of a rice powder noodle as recited in claim 3, characterized in that, in the packaging step, the packaging mode of the unit-length noodle strand accommodated and located in the gussetless packaging container is made into a packaging mode such that a flatness rate (flatness rate=(lateral dimension−thickness dimension)/lateral dimension) regulated by a lateral dimension and a thickness dimension of the unit-length noodle strand in the packaging mode becomes within a range of about 70% to 85%.

5. A manufacturing method of a rice powder noodle as recited in claim 1, characterized in that, in the raw material preparing step, an alpha rice powder as a secondary raw material powder is mixed in the rice powder as the primary raw material powder and, in the heating/alpha-transformation step, the unit-length noodle strand after being packaged is heated by an external heating for about 40 minutes to about 50 minutes so that a core temperature of each noodle strand of the unit-length noodle strand becomes a temperature within a temperature range of about 60 degrees centigrade to about 65 degrees centigrade.

6. A manufacturing method of a rice powder noodle as recited in claim 1, characterized in that, in the raw material preparing step, an alpha rice powder as a secondary raw material powder is mixed in the rice powder as the primary raw material powder and, in the heating/alpha-transformation step, the packaged unit-length noodle strand is heated by an external heating for about 30 minutes to about 40 minutes so that a core temperature of each noodle strand of the unit-length noodle strand becomes a temperature within a temperature range of about 90 degrees centigrade to about 95 degrees centigrade.

7. A manufacturing method of a fresh-type rice powder noodle as recited in claim 1, characterized in that, in the packaging step, the unit-length noodle strand is accommodated and located in the accommodating space in a packaging mode where the unit-length noodle strand is made into a doubled state equally in a longitudinal direction of the noodle strands and spread in a width direction of the noodle strands into a flattened state and where a thickness of every part in an entire width direction becomes an even thin shape over a primary area in the width direction, while keeping the packaging mode of the thin shape of the unit-length noodle strand inside the accommodating space, and the packaging mode of the unit-length noodle strand accommodated and located in the packaging container is made into a packaging mode such that a flatness rate (flatness rate=(lateral dimension−thickness dimension)/lateral dimension) regulated by a lateral dimension and a thickness dimension of the unit-length noodle strand in the packaging mode becomes within a range of about 70% to 85% or a dimension of the packaging container is set such that a number of layers of the unit-length noodle strand at a maximum thickness dimension part of the unit-length noodle strand inside the packaging container becomes within 10 to 20 layers, thereby heating evenly and uniformly not only the noodle strands at an outside but also the noodle strands even at an inside of the unit-length noodle strand in the packaging container so as to increase evenly and uniformly a binding force for the binding effect between the mutual rice powder components at least at the surface part of each of the noodle strands from the noodle strands at the outside to the noodle strands at the inside of the unit-length noodle strand.

8. A manufacturing method of a fresh-type rice powder noodle that uses a raw material containing only a rice powder as a primary raw material powder and that manufactures the rice powder noodle by a common noodle manufacturing process,
characterized by comprising:
a raw material preparing step for adding a water to a rice powder as a primary raw material powder to prepare a mixed raw material, while maintaining a non-alpha state of a rice powder component in the mixed raw material,
a kneading step for kneading the mixed raw material is to form a kneaded substance, while maintaining a non-alpha state of the rice powder component in the kneaded substance,
a pressing/extending step for pressing and extending the kneaded substance to form a noodle dough sheet, while maintaining a non-alpha state of the rice powder component in the noodle dough sheet,
a slitting step for slitting the noodle dough sheet into a predetermined noodle strand shape to obtain a continuous noodle strand as a collection of noodle strands, while maintaining a non-alpha state of the rice powder component in the continuous noodle strand,
a heating/alpha-transformation step for uniformly heating the continuous noodle strand only once at a temperature not less than a predetermined temperature, at which the rice powder component in the continuous noodle strand comes into an alpha state, via a water component in the continuous noodle strand, thereby transforming the rice powder component at least at a surface part of each noodle strand of the continuous noodle strand inside the packaging container and simultaneously sterilizing germs in the continuous noodle strands, as an alpha transformation to increase a binding/fixing force as a binding effect between the mutual rice powder components at least at the surface part of each noodle strand of the continuous noodle strand,
a unit-length cutting step for cutting the continuous noodle strand into a predetermined length to obtain individual unit-length noodle strands, and
a packaging step for accommodating and hermetically sealing the unit-length noodle strand in a pouch-like heat-resistant packaging container to obtain a packaged unit-length noodle strand.

9. A manufacturing method of a rice powder noodle as recited in claim 8, characterized in that the rice powder as the primary raw material powder has an average particle size within a range of about 10 to about 150 micrometers.

10. A manufacturing method of a fresh rice powder noodle that uses a raw material containing only a rice powder as a primary raw material powder and that manufactures the rice powder noodle by a common noodle manufacturing process,
characterized by comprising:
a raw material preparing step for adding a water to a rice powder as a primary raw material powder to prepare a mixed raw material, while maintaining a non-alpha state of a rice powder component in the mixed raw material,
a kneading step for kneading the mixed raw material is to form a kneaded substance, while maintaining a non-alpha state of the rice powder component in the kneaded substance,
a pressing/extending step for pressing and extending the kneaded substance to form a noodle dough sheet, while maintaining a non-alpha state of the rice powder component in the noodle dough sheet,
a slitting step for slitting the noodle dough sheet into a predetermined noodle strand shape to obtain a continuous noodle strand as a collection of noodle strands, while maintaining a non-alpha state of the rice powder component in the continuous noodle strand,
a unit-length cutting step for cutting the continuous noodle strand into a predetermined length to obtain individual unit-length noodle strands, while maintaining a non-alpha state of the rice powder component in the unit-length noodle strand,
a packaging step for accommodating and hermetically sealing the unit-length noodle strand in a pouch-like heat-resistant packaging container to obtain a packaged unit-length noodle strand, while maintaining a non-alpha state of the rice powder component in the noodle strand, and
a freezing step for freezing the packaged unit-length noodle strand that keeps the non-alpha state of the rice powder component as it is so as to maintain each of the noodle strands of the packaged unit-length noodle strand in a frozen state.

11. A manufacturing method of a rice powder noodle as recited in claim 1, characterized further in that,

12. A manufacturing method of a fresh-type corn powder noodle that uses a raw material containing only a corn powder as a primary raw material powder and that manufactures the corn powder noodle by a common noodle manufacturing process,
characterized by comprising:
a raw material preparing step for adding a water to a corn powder as a primary raw material powder to prepare a mixed raw material, while maintaining a non-alpha state of a corn powder component in the mixed raw material,
a kneading step for kneading the mixed raw material is to form a kneaded substance, while maintaining a non-alpha state of the corn powder component in the kneaded substance,
a pressing/extending step for pressing and extending the kneaded substance to form a noodle dough sheet, while maintaining a non-alpha state of the corn powder component in the noodle dough sheet,
a slitting step for slitting the noodle dough sheet into a predetermined noodle strand shape to obtain a continuous noodle strand, while maintaining a non-alpha state of the corn powder component in the continuous noodle strand,
a unit-length cutting step for cutting the continuous noodle strand into a predetermined length to obtain individual unit-length noodle strands, while maintaining a non-alpha state of the corn powder component in the unit-length noodle strand,
a packaging step for accommodating and hermetically sealing the unit-length noodle strand in a pouch-like heat-resistant packaging container to obtain a packaged unit-length noodle strand, while maintaining a non-alpha state of the corn powder component in the noodle strand, and
a heating/alpha-transformation step for uniformly heating the unit-length noodle strand inside the packaging container only once at a temperature not less than a predetermined temperature, at which the corn powder component in the unit-length noodle strand comes into an alpha state, via a water component in the unit-length noodle strand inside the packaging container, thereby transforming the corn powder component at least at a surface part of each noodle strand of the unit-length noodle strand inside the packaging container and simultaneously sterilizing germs in the unit-length noodle strands, as an alpha transformation to increase a binding/fixing force as a binding effect between the mutual corn powder components at least at the surface part of each noodle strand of the unit-length noodle strand.

13. A manufacturing method of a fresh-type corn powder noodle that uses a raw material containing only a corn powder as a primary raw material powder and that manufactures the corn powder noodle by a common noodle manufacturing process,
characterized by comprising:
a raw material preparing step for adding a water to a corn powder as a primary raw material powder to prepare a mixed raw material, while maintaining a non-alpha state of a corn powder component in the mixed raw material,
a kneading step for kneading the mixed raw material is to form a kneaded substance, while maintaining a non-alpha state of the corn powder component in the kneaded substance,
a pressing/extending step for pressing and extending the kneaded substance to form a noodle dough sheet, while maintaining a non-alpha state of the corn powder component in the noodle dough sheet,
a slitting step for slitting the noodle dough sheet into a predetermined noodle strand shape to obtain a continuous noodle strand as a collection of noodle strands, while maintaining a non-alpha state of the corn powder component in the continuous noodle strand,
a heating/alpha-transformation step for uniformly heating the continuous noodle strand only once at a temperature not less than a predetermined temperature, at which the corn powder component in the continuous noodle strand comes into an alpha state, via a water component in the continuous noodle strand, thereby transforming the corn powder component at least at a surface part of each noodle strand of the continuous noodle strand inside the packaging container and simultaneously sterilizing germs in the continuous noodle strands, as an alpha transformation to increase a binding/fixing force as a binding effect between the mutual corn powder components at least at the surface part of each noodle strand of the continuous noodle strand,
a unit-length cutting step for cutting the continuous noodle strand into a predetermined length to obtain individual unit-length noodle strands, and
a packaging step for accommodating and hermetically sealing the unit-length noodle strand in a pouch-like heat-resistant packaging container to obtain a packaged unit-length noodle strand.

14. A manufacturing method of a corn powder noodle as recited in claim 8, characterized in that the corn powder as the primary raw material powder has an average particle size within a range of about 10 to about 150 micrometers.

15. A manufacturing method of a fresh corn powder noodle that uses a raw material containing only a corn powder as a primary raw material powder and that manufactures the corn powder noodle by a common noodle manufacturing process,
characterized by comprising:
a raw material preparing step for adding a water to a corn powder as a primary raw material powder to prepare a mixed raw material, while maintaining a non-alpha state of a corn powder component in the mixed raw material,
a kneading step for kneading the mixed raw material is to form a kneaded substance, while maintaining a non-alpha state of the corn powder component in the kneaded substance,
a pressing/extending step for pressing and extending the kneaded substance to form a noodle dough sheet, while maintaining a non-alpha state of the corn powder component in the noodle dough sheet,
a slitting step for slitting the noodle dough sheet into a predetermined noodle strand shape to obtain a continuous noodle strand as a collection of noodle strands, while maintaining a non-alpha state of the corn powder component in the continuous noodle strand,
a unit-length cutting step for cutting the continuous noodle strand into a predetermined length to obtain individual unit-length noodle strands, while maintaining a non-alpha state of the corn powder component in the unit-length noodle strand,
a packaging step for accommodating and hermetically sealing the unit-length noodle strand in a pouch-like heat-resistant packaging container to obtain a packaged unit-length noodle strand, while maintaining a non-alpha state of the corn powder component in the noodle strand, and
a freezing step for freezing the packaged unit-length noodle strand that keeps the non-alpha state of the corn powder component as it is so as to maintain each of the noodle strands of the packaged unit-length noodle strand in a frozen state.

16. A manufacturing method of a corn powder noodle as recited in claim 10, characterized in that the corn powder as the primary raw material powder has an average particle size within a range of about 10 to about 150 micrometers.
